(19) United States
(12) Patent Application Publication
(10) Pub. No.: US 2014/0098645 A1
(43) Pub. Date: Apr. 10, 2014

(54) METHOD, SYSTEM, AND DEVICE FOR A MEDICATION REGIMEN

(71) Applicant: Baidan Pty Ltd, New South Wales (AU)

(72) Inventor: Marek Francis Mularczyk, New South Wales (AU)

(73) Assignee: Baidan Pty Ltd, New South Wales (AU)

(21) Appl. No.: 14/045,696

(22) Filed: Oct. 3, 2013

(30) Foreign Application Priority Data
Oct. 4, 2012 (AU) 2012904339

(51) Int. Cl. A61J 7/04

(52) U.S. Cl. CPC A61J 7/0481
USPC 368/10

(57) ABSTRACT

A method, system, user device and computer readable medium for indicating to a user to undertake a particular act in relation to a medication regimen. The user device is configured to receive, from a server processing system in data communication with the user device, data relating to a medication regimen; store in memory the data relating to the medication regimen; calculate, using the data relating to the medication regimen, a first point in time for the user to perform an act in relation to the medication regimen; store in memory the first point in time; and monitor whether the first point in time has been reached. In response to the first point in time being detected the user device generates an alert that is output via the user device to indicate to the user to perform the act in relation to the medication regimen.

### CROSS-REFERENCE TO RELATED APPLICATIONS

The present application claims priority from Australian Provisional Patent Application No. 2012904339 filed on 4 Oct. 2012, the content of which is incorporated herein by reference.

### FIELD OF INVENTION

The present invention relates to a method, system, mobile device, software product, and computer readable medium for indicating to a user to undertake an act in relation to a medication regimen.

### BACKGROUND

The prevalence and impact of a patient not adhering to a medication regimen has been well researched and documented. Studies have shown that over 50% of patients do not comply with their medication regimen. Failure to comply with the medication regimen can have serious consequences.

Whilst attempts have been made to provide electronic devices which remind a patient to perform an act in relation to their medication regimen, there are particular drawbacks to such attempts.

In particular, generally the user or the regimen administrator (i.e. doctor, pharmacist, etc) is required to input the times which medication is to be taken via a small keyboard interface of the electronic device which can be difficult and tedious.

Other attempts have been made where the regimen administrator enters the times to take medication via a processing system which is separate to the electronic device. The times are then transferred to a server processing system for monitoring. When a time to take medication is detected by the server processing system, an alert is transferred to the electronic device for presentation to the user. However, this method suffers from assuming that the user may always be located in an area where the electronic device can receive such an alert from the server processing system.

Additional attempts have involved the transfer of the times to take medication from the server processing system to the electronic device, wherein the electronic device monitors the times to take medication and presents the alert. This arrangement therefore overcomes the drawback of being location in an area which may be unable to receive a remotely generated alert, the arrangement does not cater for situations where the user may have missed the time to take medication. In these types of situations, a new time to take medication may need to be calculated, which requires communication between the user device and the server processing system.

There is therefore a need to assist patients with adherence of their medication regimen which overcomes or at least alleviates one or more of the above problems or provides a useful commercial alternative.

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

### SUMMARY

In a first aspect there is provided a user device for indicating to a user to undertake a particular act in relation to a medication regimen, wherein the user device includes a processor, a memory, a communication unit, and an output interface, wherein:

the communication unit receives, from a server processing system in data communication with the user device, data relating to a medication regimen;

the memory stores therein the data relating to the medication regimen;

the processor calculates, using the data relating to the medication regimen, a first point in time for the user to perform an act in relation to the medication regimen;

the memory stores the first point in time in the memory; and

the processor monitors whether the first point in time has been reached, wherein in response to the first point in time being detected the processor generates an alert which is output via the output interface to indicate to the user to perform the act in relation to the medication regimen.

In certain embodiments, the user device includes an input interface which receives user input from the user indicating that the act has been performed, wherein data indicative of the user input is stored in the memory.

In certain embodiments, the processor calculates, prior to the first point in time and using the data relating to the medication regimen, a second point in time which occurs after the first point in time and indicative of non-compliance in relation of the medication regimen, wherein in the event that the user provides the user input indicating that the act was performed between the first point in time and the second point in time, the processor stores in the memory a compliance record.

In certain embodiments, the processor controls the communication device to transfer the compliance record to the server processing system for recordal.

In certain embodiments, in response to the user providing the user input indicating that the act was performed between the first point in time and the second point in time, the processor controls the output device to cease output of the alert, calculates a next point in time to perform a next act in relation to the medication regimen based on the data indicative of the medical regimen, stores the next point in time in the memory, and monitors the next point in time to output a respective alert in relation to the next act.

In certain embodiments, in the event that the user fails to provide the user input indicating that the act was performed between the first point in time and the second point in time, the processor stores in the memory a non-compliance record.

In certain embodiments, the processor controls the communication device to transfer the non-compliance record to the server processing system for recordal.

In certain embodiments, the processor calculates, prior to the first point in time and using the data relating to the medication regimen, a third point in time which occurs after the second point in time, wherein the processor stores the third point in time in the memory, wherein in the event that the user fails to provide the user input indicating that the act was performed between the second point in time and the third point in time, the processor controls the output device to cease output of the alert.

In certain embodiments, the data stored in the memory relating to the medication regimen includes missed act data, wherein in response to the user failing to provide the user input indicating that the act was performed between the second point in time and the third point in time, the processor outputs via the output device a missed act alert indicating whether the act is to be performed by the user in accordance with the missed act data, and wherein the processor calculates the next point in time to perform the next act additionally based on the missed act data.

In certain embodiments, the user inputs, via the input interface, meal time data indicative of a plurality of times which meals are expected to occur for the user, wherein the processor stores the meal time data in the memory, wherein the processor calculates the first point in time additionally based on the meal time data stored in the memory.

In certain embodiments, the user inputs, via the input interface, sleep time data indicative of a time which the user expects to go to sleep, wherein the processor stores in the sleep time data in the memory, wherein the processor calculates the first point in time additionally based on the sleep time data stored in the memory.

In certain embodiments, the alert is at least partially output visually via the output interface.

In certain embodiments, the alert is at least partially output audibly via the output interface.

In certain embodiments, the user device includes a tactile module which is controllable by the processor, wherein the alert is at least partially output by the tactile module under control of the processor.

In certain embodiments, the user device is one of:

a mobile telecommunication device; and

a mobile communication device.

In another aspect there is provided a system for indicating to a user to undertake a particular act in relation to a medication regimen, wherein the system includes a server processing system in data communication with a user device, wherein:

the server processing system includes a server processor and a server communication unit, wherein:
the server communication unit receives, from a regimen administrator processing system, first data relating to a medication regimen;
the processor stores the medication regimen in the memory associated with or accessible by the server processing system; and
the server communication unit transfers second data relating to the medication regimen to the user device; and

the user device includes a processor, a memory, a communication unit, and an output interface, wherein:
the communication unit receives, from the server processing system, the second data;
the memory stores therein the second data relating to the medication regimen;
the processor calculates, using the second data relating to the medication regimen, a first point in time for the user to perform an act in relation to the medication regimen;
the memory stores the first point in time in the memory; and
the processor monitors whether the first point in time has been reached, wherein in response to the first point in time being detected the processor generates an alert which is output via the output interface to indicate to the user to perform the act in relation to the medication regimen.

In certain embodiments, the processor calculates and stores in the memory, prior to the first point in time and using the second data relating to the medication regimen, a second point in time which occurs after the first point in time and indicative of non-compliance in relation of the medication regimen, wherein in the event that the user fails to provide user input via an input interface of the user device indicating that the act was performed between the first point in time and the second point in time, the processor stores in the memory a non-compliance record which is transferred to the server processing system for recordal.

In certain embodiments, the server processor receives a plurality of non-compliance records from the user device, wherein the server processor determines whether a non-compliance threshold has been satisfied based on at least some of the plurality of non-compliance records received from the user device, and in response to a positive determination the server processing system transfers an electronic message indicative of the user's non-compliance to at least one of a regimen administrator associated with the regimen administrator processing system, a carer associated with the user, and an emergency contact associated with the user.

In certain embodiments, the system includes the regimen administrator processing system which is operated by a regimen administrator to provide the first data indicative of the medication regimen.

In another aspect there is provided a non-transient computer readable medium including executable instructions for configuring a user device to indicate to a user to undertake a particular act in relation to a medication regimen, wherein the user device includes a processor, a memory, a communication unit, and an output interface, wherein upon execution of the executable instructions the user device is configured to:

receive, from a server processing system in data communication with the user device and via the communication unit, data relating to a medication regimen;

store, in the memory, the data relating to the medication regimen;

calculate, using the processor and the data relating to the medication regimen, a first point in time for the user to perform an act in relation to the medication regimen;

store, in the memory, the first point in time; and

monitor, using the processor, whether the first point in time has been reached, wherein in response to the first point in time being detected the processor generates an alert which is output via the output interface to indicate to the user to perform the act in relation to the medication regimen.

In another aspect there is provided a user device for indicating to a user to undertake a particular act in relation to a medication regimen, wherein the device is configured to:

receive, from a server processing system, data relating to a medication regimen;

monitor, based on the data, a point in time to perform an act in relation to the medication regimen; and

generate, upon detecting the point in time, an alert to indicate to the user to undertake the act.

In another aspect there is provided a system for indicating to a user to undertake a particular act in relation to a medication regimen, wherein the system includes:

a server processing system configured to receive, from a regimen administrator, first data relating to a medication regimen; and

a user device in data communication with the server processing system, wherein the user device is configured to:
receive, from a server processing system, second data relating to a medication regimen;
monitor, based on the second data, a point in time to perform an act in relation to the medication regimen; and
generate, upon detecting the point in time, an alert to indicate to the user to undertake the act.

In another aspect there is provided a system for indicating to a user to undertake a particular act in relation to a medication regimen, wherein the system includes:

a regimen administrator processing system configured to define, via input by a regimen administrator, first data relating to a medication regimen;

a server processing system configured to receive, from a regimen administrator processing system, the first data relating to the medication regimen; and

a user device in data communication with the server processing system, wherein the user device is configured to:
receive, from a server processing system, second data relating to a medication regimen;
monitor, based on the second data, a point in time to perform an act in relation to the medication regimen; and
generate, upon detecting the point in time, an alert to indicate to the user to undertake the act.

In another aspect there is provided a method for indicating to a user to undertake a particular act in relation to a medication regimen, wherein the method includes, in a user device, steps of:

receiving, from a server processing system, data relating to a medication regimen;

monitoring, based on the data, a point in time to perform an act in relation to the medication regimen; and

generating, upon detecting the point in time, an alert to indicate to the user to undertake the act.

In another aspect there is provided a method for indicating to a user to undertake a particular act in relation to a medication regimen, wherein the method includes:

a server processing system receiving, from a regimen administrator, first data relating to a medication regimen;

the server processing system transferring, to a user device, second data relating to a medication regimen;

the user device monitoring, based on the second data, a point in time to perform an act in relation to the medication regimen; and

generating, upon detecting the point in time, an alert to indicate to the user to undertake the act.

In another aspect there is provided a method for indicating to a user to undertake a particular act in relation to a medication regimen, wherein the method includes:

a regimen administrator processing system configured to define, via input from a regimen administrator, first data relating to a medication regimen;

a server processing system configured to receive, from a regimen administrator processing system, the first data relating to the medication regimen; and

a user device in data communication with the server processing system, wherein the user device is configured to:
receive, from a server processing system, second data relating to a medication regimen;
monitor, based on the second data, a point in time to perform an act in relation to the medication regimen; and
generate, upon detecting the point in time, an alert to indicate to the user to undertake the act.

In another aspect there is provided a computer readable medium including executable instructions for configuring a mobile communication device to indicate to a user to undertake a particular act in relation to a medication regimen, wherein the computer readable medium configure the mobile communication device to:

receive, from a server processing system, data relating to a medication regimen;

monitor, based on the data, a point in time to perform an act in relation to the medication regimen; and

generate, upon detecting the point in time, an alert to indicate to the user to undertake the act.

In another aspect there is provided software including executable instructions for configuring a mobile communication device to indicate to a user to undertake a particular act in relation to a medication regimen, wherein the software, when executed by the mobile communication device, configures to mobile communication device to:

receive, from a server processing system, data relating to a medication regimen;

monitor, based on the data, a point in time to perform an act in relation to the medication regimen; and

generate, upon detecting the point in time, an alert to indicate to the user to undertake the act.

Other aspects and embodiments will be appreciated throughout the description provided herein.

### BRIEF DESCRIPTION OF THE FIGURES

Example embodiments should become apparent from the following description, which is given by way of example only, of at least one preferred but non-limiting embodiment, described in connection with the accompanying figures.

FIG. 1 illustrates a functional block diagram of an example processing device that can be utilised to embody or give effect to a particular embodiment;

FIG. 2 illustrates an example network infrastructure that can be utilised to embody or give effect to a particular embodiment;

FIG. 3A is a functional block diagram of an example system for indicating to a user to undertake a particular act in relation to a medication regimen;

FIG. 3B is a functional block diagram of an example system for indicating to a user to undertake a particular act in relation to a medication regimen;

FIG. 4 is a flowchart representing an example method for indicating to a user to undertake a particular act in relation to a medication regimen;

FIG. 5A is a screenshot of an example patient administration interface for a regimen administrator view medication of a patient;

FIG. 5B is another screenshot of an example patient administration interface for a regimen administrator view medication of a patient;

FIG. 5C is another screenshot of an example patient administration interface for a regimen administrator view medication of a patient;

FIG. 6 is a flowchart representing a method for indicating to a user to undertake a particular act in relation to a medication regimen;

FIG. 7A is an example of a user device with presenting visual information of a generated alert;

FIG. 7B is another example of a user device presenting further visual information in relation to the generated alert and a request for user feedback;

FIG. 8 is an example of a flowchart illustrating an example method performed by the user device for calculating a next point in time to monitor for a medication regimen;

FIGS. 9A, 9B and 9C are an example of a table representing a frequency matrix;

FIG. 10 is an example of a block-out table;

FIG. 11 is an example of a meal relationship table; and

FIG. 12 is an example of a drops table; and

FIG. 13 is an example flowchart illustrating a further example method performed by the user device for calculating a next point in time to monitor for a medication regimen.

### DETAILED DESCRIPTION OF EXAMPLE EMBODIMENTS

The following modes, given by way of example only, are described in order to provide a more precise understanding of the subject matter of a preferred embodiment or embodiments.

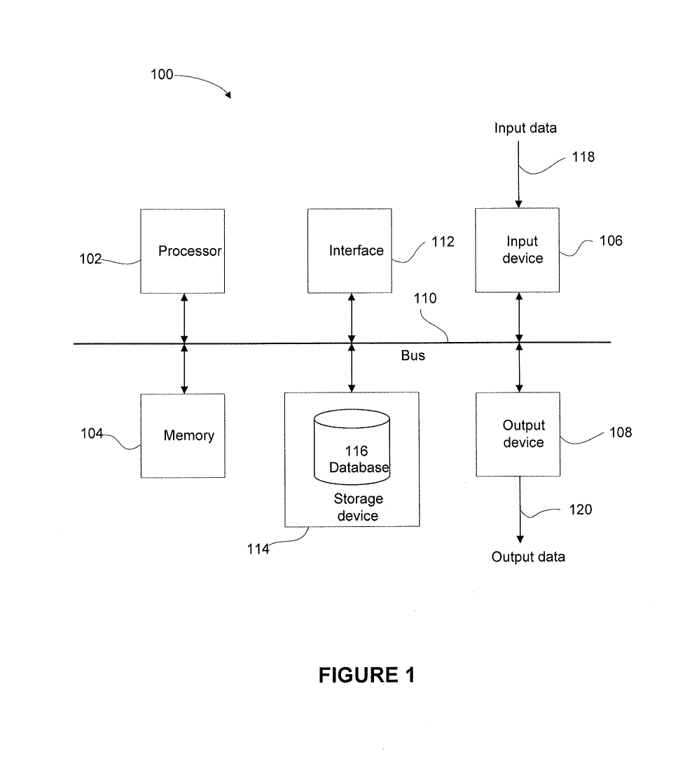

A particular embodiment of the present invention can be realised using a processing device, an example of which is shown in FIG. 1. In particular, the processing device 100 generally includes at least one processor 102, or processing unit or plurality of processors, memory 104, at least one input device 106 and at least one output device 108, coupled together via a bus or group of buses 110. In certain embodiments, input device 106 and output device 108 could be the same device. An interface 112 can also be provided for coupling the processing device 100 to one or more peripheral devices, for example interface 112 could be a PCI card or PC card. At least one storage device 114 which houses at least one database 116 can also be provided. The memory 104 can be any form of memory device, for example, volatile or non-volatile memory, solid state storage devices, magnetic devices, etc. The processor 102 could include more than one distinct processing device, for example to handle different functions within the processing device 100.

Input device 106 receives input data 118 (such as electronic content data), for example via a network or from a local storage device. Output device 108 produces or generates output data 120 (such as viewable content) and can include, for example, a display device or monitor in which case output data 120 is visual, a printer in which case output data 120 is printed, a port for example a USB port, a peripheral component adaptor, a data transmitter or antenna such as a modem or wireless network adaptor, etc. Output data 120 could be distinct and derived from different output devices, for example a visual display on a monitor in conjunction with data transmitted to a network. A user could view data output, or an interpretation of the data output, on, for example, a monitor or using a printer. The storage device 114 can be any form of data or information storage means, for example, volatile or non-volatile memory, solid state storage devices, magnetic devices, etc.

Examples of electronic data storage devices 114 can include disk storage, optical discs, such as CD, DVD, Blu-ray Disc, flash memory/memory card (e.g., solid state semiconductor memory), MultiMedia Card, USB sticks or keys, flash drives, Secure Digital (SD) cards, microSD cards, miniSD cards, SDHC cards, miniSDSC cards, solid-state drives, and the like.

In use, the processing device 100 is adapted to allow data or information to be stored in and/or retrieved from, via wired or wireless communication means, the at least one database 116. The interface 112 may allow wired and/or wireless communication between the processing unit 102 and peripheral components that may serve a specialised purpose. The processor 102 receives instructions as input data 118 via input device 106 and can display processed results or other output to a user by utilising output device 108. More than one input device 106 and/or output device 108 can be provided. It should be appreciated that the processing device 100 may be any form of terminal, PC, laptop, notebook, tablet, smart phone, specialised hardware, or the like.

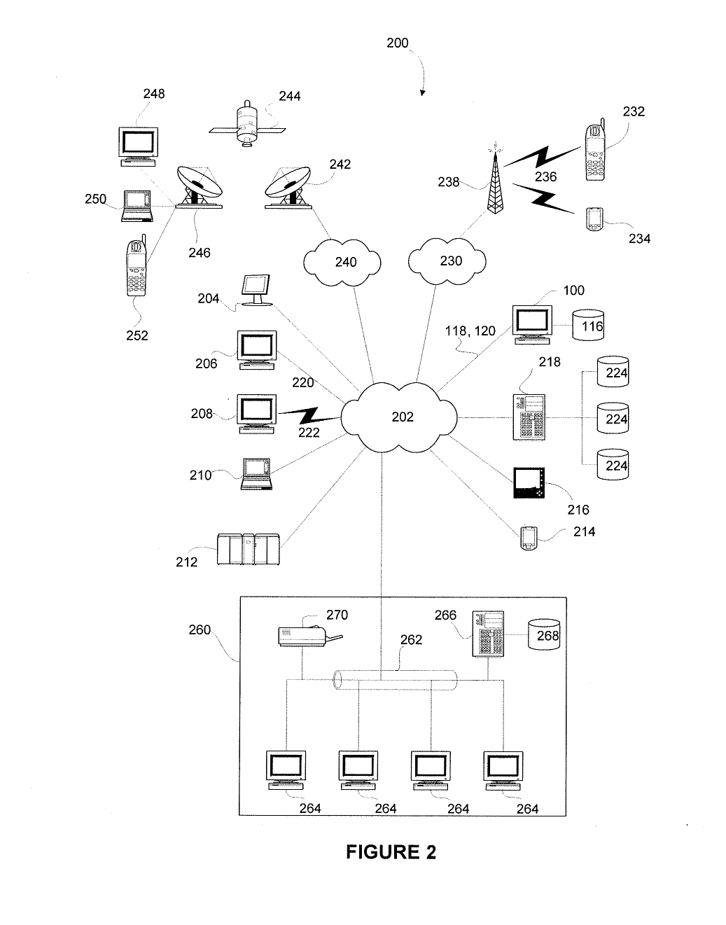

The processing device 100 may be a part of a networked communications system 200, as shown in FIG. 2. Processing device 100 could connect to network 202, for example the Internet or a WAN. Input data 118 and output data 120 could be communicated to other devices via network 202. Other terminals, for example, thin client 204, further processing systems 206 and 208, notebook computer 210, mainframe computer 212, PDA 214, pen-based computer 216, server 218, etc., can be connected to network 202. A large variety of other types of terminals or configurations could be utilised. The transfer of information and/or data over network 202 can be achieved using wired communications means 220 or wireless communications means 222. Server 218 can facilitate the transfer of data between network 202 and one or more databases 224. Server 218 and one or more databases 224 provide an example of an information source.

Other networks may communicate with network 202. For example, telecommunications network 230 could facilitate the transfer of data between network 202 and mobile or cellular telephone 232 or a PDA-type device 234, by utilising wireless communication means 236 and receiving/transmitting station 238. Satellite communications network 240 could communicate with satellite signal receiver 242 which receives data signals from satellite 244 which in turn is in remote communication with satellite signal transmitter 246. Terminals, for example further processing system 248, notebook computer 250 or satellite telephone 252, can thereby communicate with network 202. A local network 260, which for example may be a private network, LAN, etc., may also be connected to network 202. For example, network 202 could be connected with ethernet 262 which connects terminals 264, server 266 which controls the transfer of data to and/or from database 268, and printer 270. Various other types of networks could be utilised.

The processing device 100 is adapted to communicate with other terminals, for example further processing systems 206, 208, by sending and receiving data, 118, 120, to and from the network 202, thereby facilitating possible communication with other components of the networked communications system 200.

Thus, for example, the networks 202, 230, 240 may form part of, or be connected to, the Internet, in which case, the terminals 206, 212, 218, for example, may be web servers, Internet terminals or the like. The networks 202, 230, 240, 260 may be or form part of other communication networks, such as LAN, WAN, ethernet, token ring, FDDI ring, star, etc., networks, or mobile telephone networks, such as GSM, CDMA or 3G, etc., networks, and may be wholly or partially wired, including for example optical fibre, or wireless networks, depending on a particular implementation.

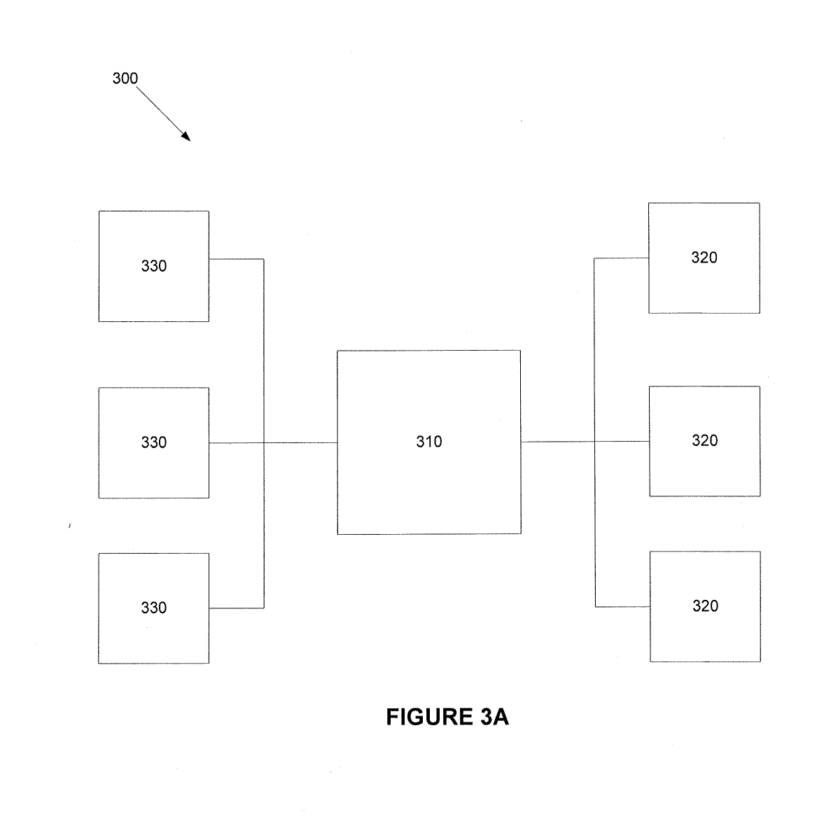

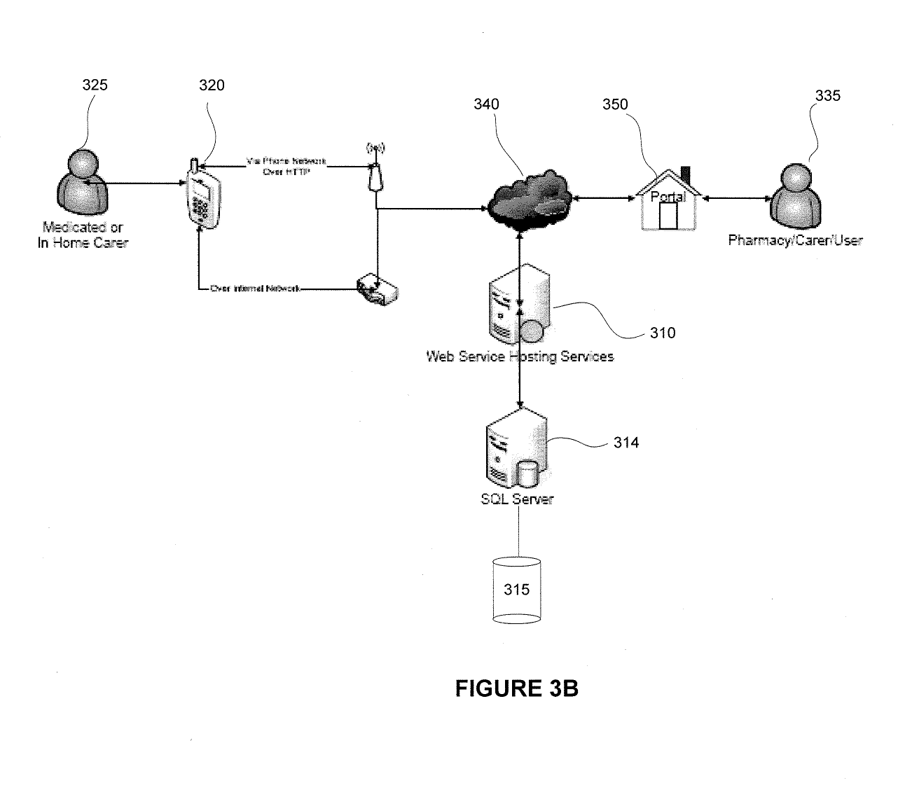

Referring to FIG. 3A, there is illustrated a system 300 for indicating to a user to undertake an act in relation to a medication regimen.

In particular, the system 300 includes at least one regimen administrator processing system 330 which is in data communication with at least one server processing system 310, which is in turn in data communication with at least one user device 320. The data communication between regimen administrator processing system 330, the server processing system 310 and the user device 320 can be performed via one or more networks 340 (see FIG. 3B) such as the Internet, a telecommunication network, a local area network, a wide area network, or the like. The server processing system 310 generally includes a database server 314 controlling a patient database 315.

Preferably, the user device 320 is a mobile communication device such as a mobile telecommunication device. More preferably, the mobile communication device 320 is a smart phone or computer tablet which is able to be configured via a software product downloadable from a software repository in order to operate within the system 300 to indicate to the user 325 of the smart phone to undertake an act in relation to a medication regimen. The user device may be operated by the patient or another person on behalf of the patient, such as a carer or the like.

Preferably the system 300 includes a plurality of regimen administrator processing systems 330 as shown in FIG. 3A. Generally, each regimen administrator processing system 330 can be a general processing system as described in relation to processing system 100. Each regimen administrator processing system 330 is operated by a respective regimen administrator 335 in order to define first data relating to the medication regimen. The regimen administrator can be an authority who is registered with the server processing system to define a medication regimen for a user 325, such as a doctor, a pharmacist, a nurse, a medical professional, a carer or the like. It will be appreciated that more than one regimen administrator can have input defining the medication regimen for a user.

Each regimen administrator processing system 330 generally includes a web browser to view a portal 350 presenting a regimen administrator interface hosted by the server processing system 310. Each regimen administrator 335 is required to be authenticated by the server processing system 310 in order to access and interact with the regimen administrator interface such as to view data stored by the server processing system 310 and to define first data relating to a medication regimen. Generally, a username and password combination may be input by the regimen administrator 335 via a login web page, wherein data indicative of the username and password combination is transferred to the server processing system 310 for authentication against login data stored by the server processing system 310. In the event of successful authentication, the server processing system 310 can transfer to the regimen administrator processing system 330 data indicative of the regimen administrator interface.

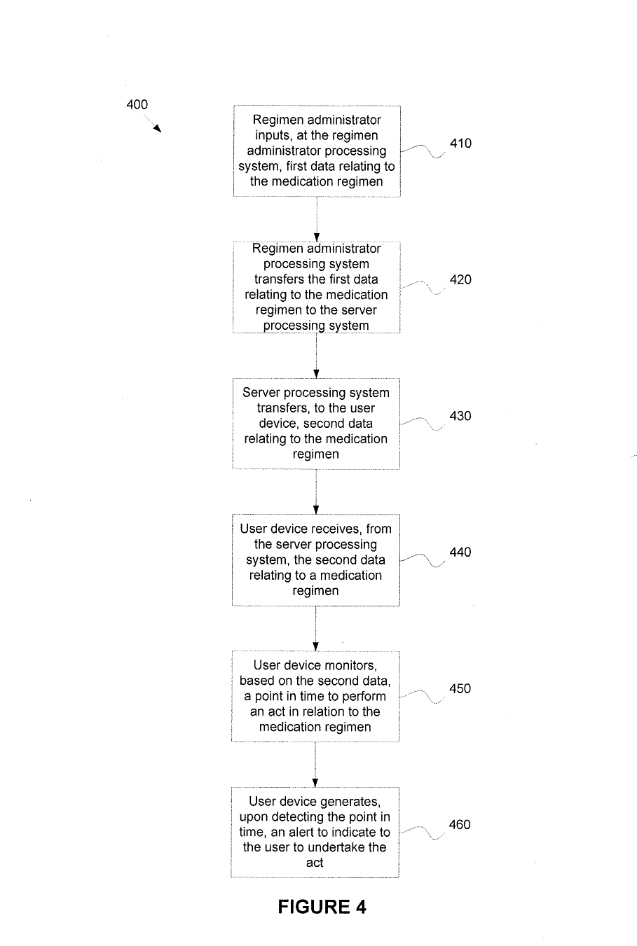

Referring to FIG. 4 there is shown a flowchart representing a method 400 for indicating to a user 325 to undertake an act in relation to a medication regimen. The method 400 will be described with reference to system 300. For clarity purposes, the method will be described with relation to a single regimen administrator processing system 330 in data communication with a single server processing system 310 which in turn is in data communication with a single user device 320. However, it will be appreciated from system 300 that the method can operate for multiple regimen administrator processing systems 330, multiple server processing systems 310 and/or multiple user devices 320.

In particular, at step 410, the method 400 includes the regimen administrator 335 inputting, at the regimen administrator processing system 330, first data relating to the medication regimen. This may include defining a new medication regimen or potentially editing an existing medication regimen.

At step 420, the method includes the regimen administrator processing system 330 transferring the first data relating to the medication regimen to the server processing system 310. Generally, the server processing system 310 stores data in a database, wherein the data stored is based upon to the first data received from the regimen administrator processing system 330.

At step 430, the method includes the server processing system 310 transferring, to the user device 320, second data relating to the medication regimen. Generally, the second data is generated based on the first data received from the regimen administrator processing system 330. However, the second data may include additional information which can include data generated or obtained from a server database 315. Additionally or alternatively, the first data may include additional information which is not provided in the second data which is transferred to the user device 320.

At step 440, the method includes the user device 320 receiving, from the server processing system 310, the second data relating to a medication regimen. Generally, the user device 320 stores the second data in non-volatile memory of the user device 320.

At step 450, the method includes the user device 320 monitoring, based on the second data, a point in time to perform an act in relation to the medication regimen. Generally, the user device 320 utilises an internal clock to monitor the point in time to perform an act. This is particularly advantageous as the user device 320 can monitor the point in time to perform the act without receiving additional information from an external source, such as the server processing system 310 or the like. Therefore, in instances where the user device 320 is not in data communication with an external source, such as the server processing system 310, the user device can still monitor the point in time and generate the alert accordingly.

At step 460, the method includes the user device 320 generating, upon detecting the point in time, an alert to indicate to the user 325 to undertake the act. The alert may include a visual and/or audio indication. Visual information may include a name of the medication, a dosage, a form or measure (i.e. a tablet, drop, etc.), due time and date, and/or instructions, In additional or alternate forms, a graphic may also be displayed on the user interface of the user device 320, wherein the graphic may be indicative of the medication in order to assist ease of identification of the medication which is required to be taken.

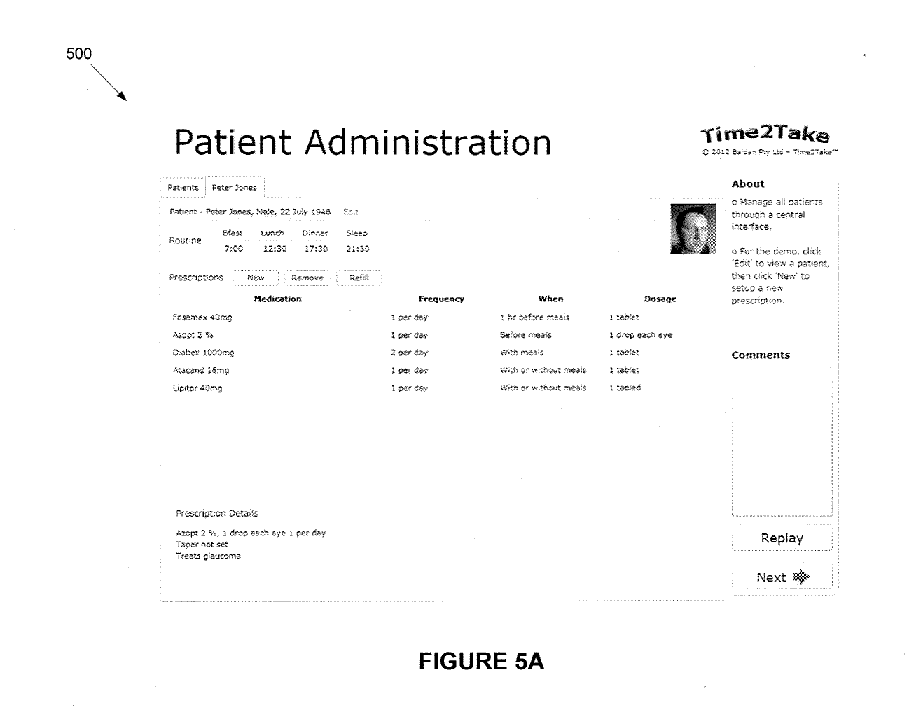

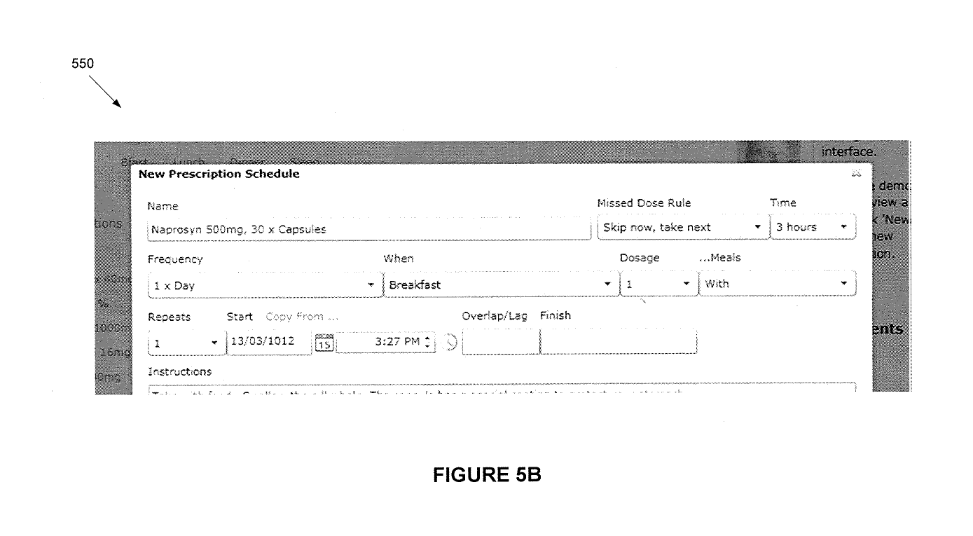

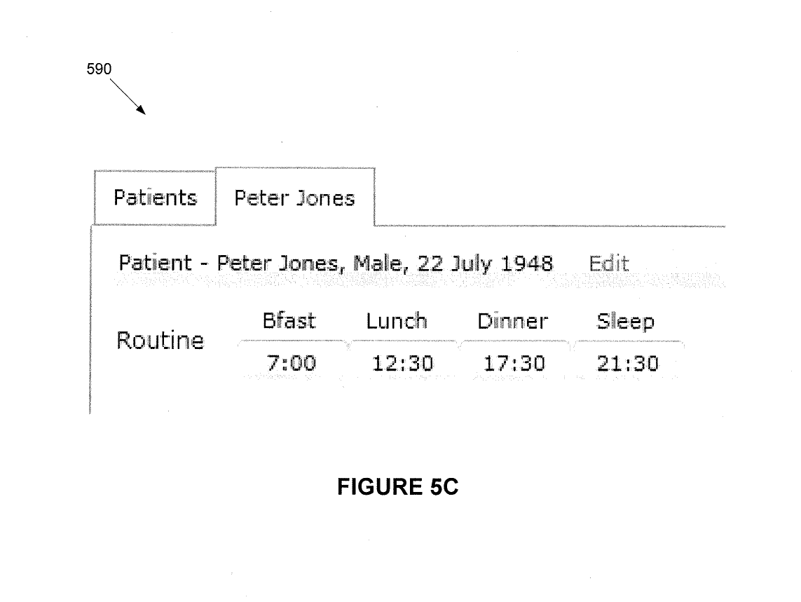

Referring to FIG. 5A there is shown a screenshot of an example of the regimen administrator interface 500. In particular, the regimen administrator interface 500 enables the regimen administrator 335 to view the current medication regimen associated with a particular user 325. The regimen administrator can input an identifier associated with the user 325, wherein the server processing system 310 receives the identifier, conducts a search for medication data associated with the user 325, and upon successful identification the server processing system 310 transfers record data indicative of the user's current medication to the regimen administrator processing system 330. The regimen administrator 335 can then take into account the user's current medication prior to defining a medication regimen for a new medication.

Referring to FIG. 5B there is shown a screenshot of an example of the regimen administrator interface 550 wherein the regimen administrator 335 is able to define first data relating to a medication regimen. In particular, a user 325 may not have any medication regimen that they are currently undertaking. In this instance, a new medication regimen is defined by the regimen administrator 335 for the user 325. However, in other instances, a user 325 may already be undertaking a medication regimen, wherein the regimen administrator 335 amends the currently stored medication regimen. In one particular form, the regimen administrator 335 may define a new medication which the user 325 is required to take. Additionally or alternatively, the regimen administrator 335 may amend existing medications of the existing medication regimen to take into account the new medication. For example, the regimen administrator may be substituting one medication for another.

The server processing system 310 may be configured to auto-populate particular fields of the regimen administrator interface 550 when a new medication regimen is being defined or an existing medication regimen is being edited. The server processing system 310 can include a data store such as a database 315 including a plurality of records for a plurality of medications. Each record can include a medication name and one or more default values for data associated with the respective medication. For example, default values for particular fields may cover the default frequency which the medication is to be taken and a dosage. The regimen administrator 335 can select a medication, such as from a pull down menu or the like, wherein upon selection, selection data is transferred to the server processing system 310. The server processing system 310 then determines default values associated with selected medication based on the data in the database 315, and transfers data back to the regimen administrator processing system 330 such that the default value are dynamically displayed to the regimen administrator 335 accordingly. The regimen administrator interface 550 can be configured to request positive confirmation of pre-populated fields in order for the default values to apply.

The server processing system 310 can include an integrity rule set which is applied by the server processing system 310 when a medication regimen is being newly defined or edited. In particular, the integrity rules are applied by the server processing system 310 to identify if an unreasonable medication regimen has been defined by the regimen administrator 335, wherein potentially a typographical error has occurred or the like. In the event that upon applying the integrity rule set to a user's medication regimen the server processing system 310 identifies an integrity error, a warning may be generated and transferred from the server processing system 310 to the regimen administrator processing system 330. In some forms, the regimen administrator 335 may override the warning.

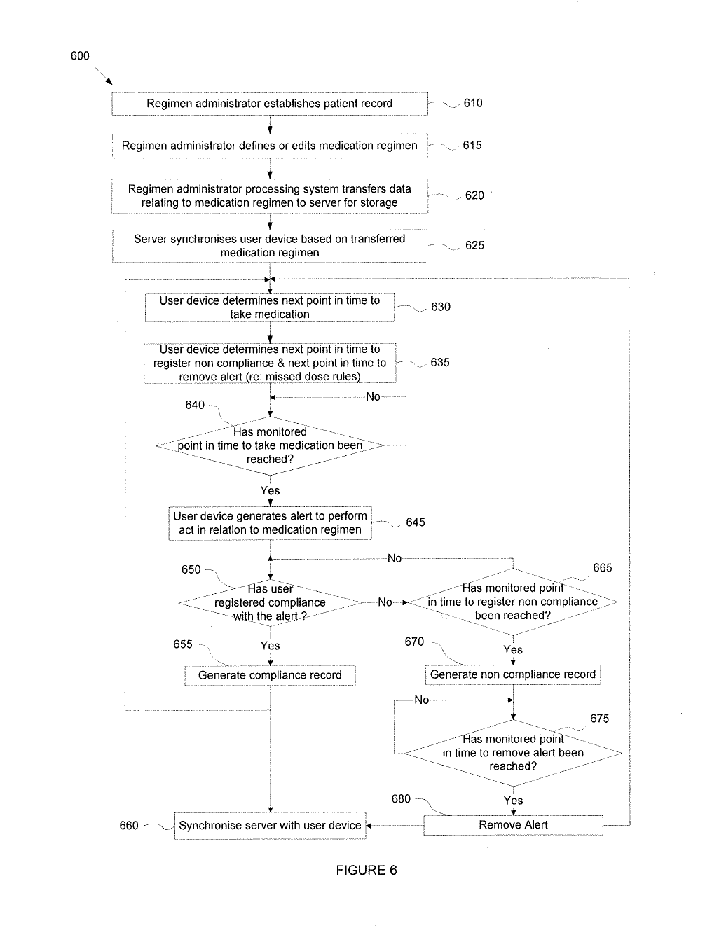

Referring to FIG. 6 there is shown a flowchart representing a further method 600 for indicating to a user 325 to undertake an act in relation to a medication regimen.

At step 610, the method 600 includes the regimen administrator 335 establishing a patient record in the patient database 315 maintained by the server processing system 310. Generally, the regimen administrator 335 can login to access the regimen administrator interface, and indicate using an input device of the regimen administrator processing system 330 that a new record is to be generated and stored in the patient database 315. Details of the patient that are stored in the patient database 315 can include the patient's name, date of birth, a unique identifier (such as a medical number or the like), and a patient routine. The patient routine can indicate at least one of a breakfast time, a lunch time, a dinner time and a sleeping time. FIG. 5C shows an example screenshot of another example of the regimen administrator interface 590 where the regimen administrator 335 defines patient routine data indicative of the patient's routine. This step is generally only performed once in order to establish a record in the patient database 315. However, it is possible that if the patient's routine alters, the regimen administrator 335 can login to the regimen administrator interface and edit one or more of the time recorded accordingly. Once the details have been input by the regimen administrator 335, the patient data is transferred from the regimen administrator processing system 330 to the server processing system 310 for recordal in the patient database 315.

At step 615, the method 600 includes the regimen administrator 335 defining or editing a patient's medication regimen. This process has been described previously in relation to FIG. 4. A point in time when particular medication is to be taken may be defined relative to the patient's routine. For example, a particular medication may require that a tablet be taken 1 hour before meals. Therefore, the medication regimen for this particular medication may be defined relative to the patient's routine rather than defining a specific point in time. In the event that the patient's routine changes, the points in time to take particular medication are dynamically determined due to the reference changing.

Additionally, the regimen administrator 335 may upload a graphic of the medication via the regimen administrator interface. Alternatively the server processing system 310 may automatically reference the graphic associated with the selected medication in the stored database and upload to the patient database 315.

At step 620, the regimen administrator processing system 330 transfers the defined medication regimen to the server processing system 310 for storage in the patient database 315. The record for the patient is identified based on the unique identity associated with the patient, wherein the new medication regimen is stored accordingly. Preferably, the database maintains data indicative of the previous regimen such that in the event that regimen administrator requires historical records to determine a further modification to the medication regimen, the historical data can be retrieved from the patient database 315 accordingly.

At step 625, the method includes the server processing system 310 synchronising the user device 320 with the patient database 315 based upon based on the data received from the regimen administrator processing system 330. In particular, in the event that the user 325 operates a mobile communication device 320 as the user device 320, the user 325 can download a software application from a software repository processing system which configures the mobile communication device 320 to communicate with the server processing system 310 accordingly.

Upon installation of the software application, the user 325 may be required to provide identification details in order to authenticate the user 325. In particular, details such as the user's unique identity (such as a government issued medical identity number), full name, date of birth and/or address may be requested. These user details and an identity of the mobile communication device 320 are then transferred to the server processing system 310 to authenticate the user 325. In the event that the user 325 is authenticated against patient details recorded in the patient database 315, the identity of the mobile communication device 320 is associated with the patient record.

The server processing system 310 then generates second data based upon the data stored in the patient database 315 and the data received from the regimen administrator processing system 330, which is then transferred to the mobile communication device 320.

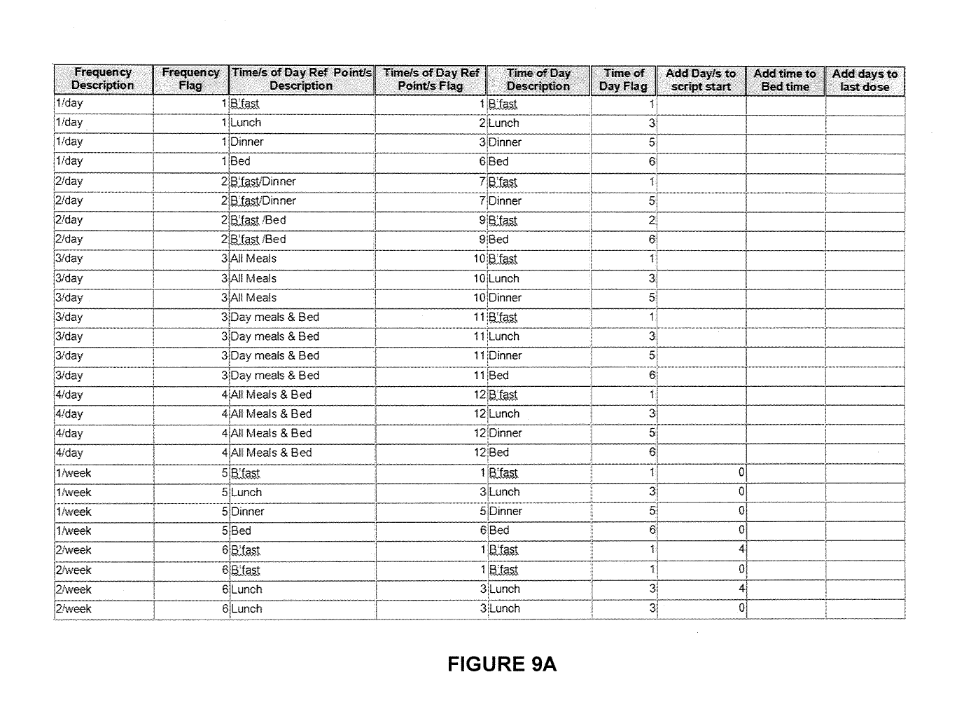

The software configured mobile communication device 320 has stored in local memory table data indicative of a number of tables which can be used by the mobile communication device 320 to determine the next point in time to monitor for taking the medication. In particular, the number of tables include a frequency matrix, a block-out table, and a meal relationship table. Use of these tables will be described in more detail with reference to FIG. 8.

At step 630, the user device 320 determines the next point in time to monitor for taking the medication using the second data received from the server processing system 320 and one or more of the tables. As indicated previously, this process will be discussed in more detail with reference to FIG. 8.

At step 635, the user device 320 determines:
the next point in time to monitor for registering non compliance; and
the next point in time to monitor to remove the alert
   both using the second data received from the server processing system 320 and one or more of the tables.

At step 640, the user device 320 operates in a monitoring mode to determine if a particular point in time defined for the medication regimen has occurred. As discussed previously, an internal clock such as that which operates using the internal processor of the user device 320 is utilised to monitor an approaching point in time.

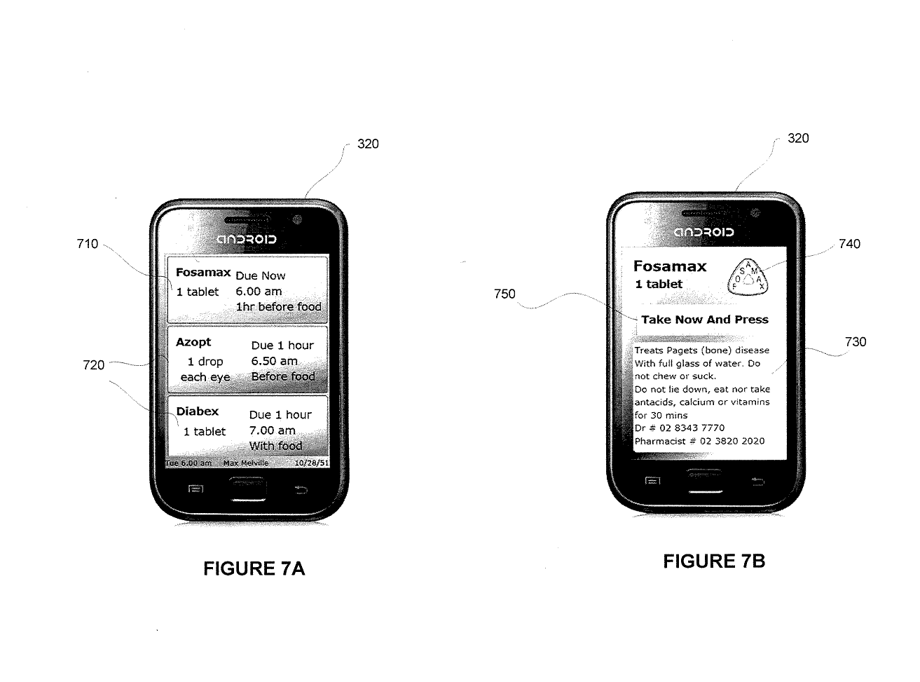

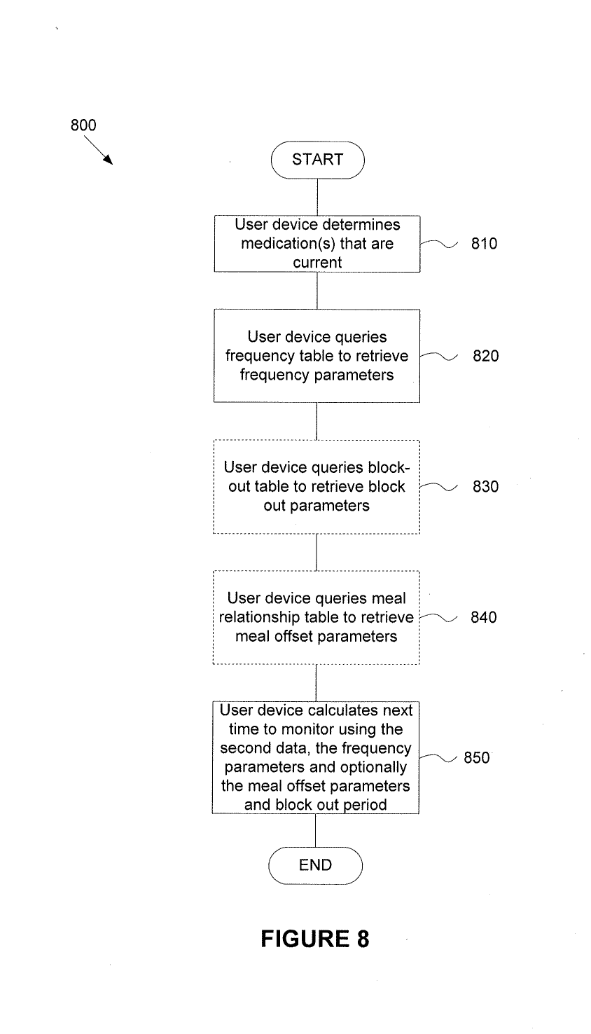

Once the user device 320 detects that a monitored point in time for taking the medication has been reached in relation to the medication regimen, the user device 320 generates an alert at step 645. As previously discussed, a visual and/or audio indication will be present via the user device 320. In another form, a tactile indication, such as a vibratory indication, may be actuated by the user device 320 in order to indicate that an act is required by the user 325. An example alert 710 is shown in FIG. 7A. In addition to indicating to the user 325 the current act of the medication regimen which is required, the user device 320 indicates upcoming acts 720 of the medication regimen. The current act and the upcoming acts are distinguished by different colouring schemes and text. In one example, the text of the alert may change from “Due at 15:00” to “Due Now from 15:00” when the point in time has been detected by the user device.

The user 325 is able to select the alert, wherein the user 325 is presented additional information regarding the act to be performed, as shown in FIG. 7B. A graphic of the medication is shown 740 and more detailed information 730 relating to the act to be performed is presented to the user 325. The user device alert interface also includes an interface element 750 such as a button which can be pressed to obtain user feedback once the act has been performed.

At step 650, where the user registers compliance as per interface element 750 above, the process moves to step 655 below. Where compliance is not registered, the process stream moves to step 665 as described later.

At step 655, the method 600 includes the user device 320 generating and storing compliance data in memory of the user device 320. In particular, the user 325 may provide feedback via the user device 320 regarding whether the act was performed. The user device 320 may record compliance data in non-volatile memory of the user device 320.

At step 655 the user device monitors an estimate of the amount of medication remaining for the patient from the dispensation volume less the cumulative dosages advised to the patient.

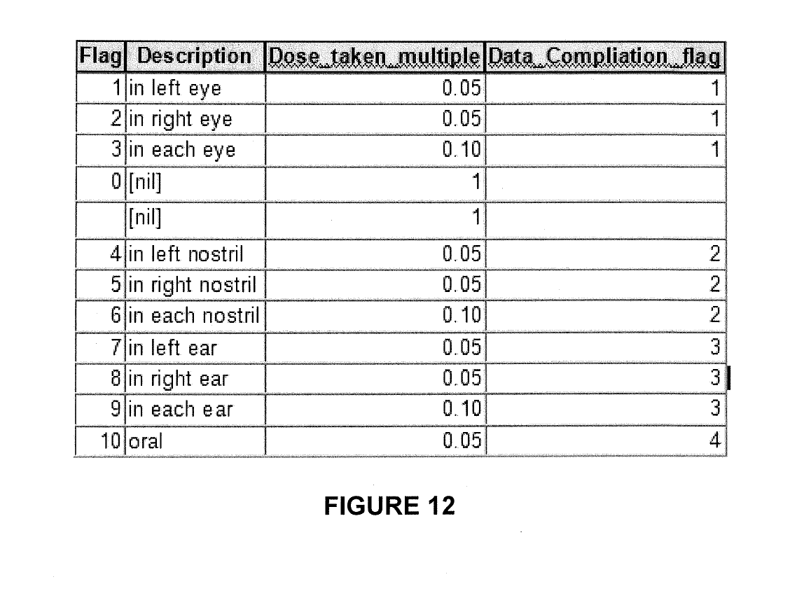

In the event that the medication dosage is described as drops to be taken by a patient are (for example, eye drops) rather than millilitres, tablets etc, the user device 320 may query a drop table, as shown for example in FIG. 12 to identify the amount of liquid to be used for the specific task of the medication regimen and additionally the description to present to the user upon the display of the user device 320. The remaining medication record may be adjusted according to the amount of liquid which is expected to have been expelled from the liquid container in order to monitor an estimate of the amount of medication remaining for the patient.

In the event that the user 325 fails to provide input before the point in time to register non compliance, the user device 320 monitors this missed dose deadline (step 665) and creates a non compliance record (step 670). Further if the point in time to remove the alert has been reached (step 675), the alert is removed (step 680). In the event that the medication is taken between the monitored point in time but prior to the missed dose deadline, the user device 320 records in the compliance record the time which missed dose was taken.

At step 660, the method 600 includes synchronising the user device 320 with the server processing system 310. In particular, compliance and non compliance data may be transferred to the server processing system 310 for recordal in the patient database 315.

The method then proceeds back to step 630 in order to recalculate the next point in time to monitor for the medication regimen. Thus, steps 630 to 660 are repeated until the medication regimen has concluded (i.e. the patient is no longer required to take medication, the patient's supply of medication has exhausted, etc). Where medications are not registered as taken, steps 665 to 680 are instead processed before returning to step 630.

Referring to FIG. 8 there is shown a method 800 for the user device 320 to calculate the next monitored point in time for the medication regimen of the patient.

In particular, at step 810, the method 800 includes the user device determining the current medication for the patient. In particular, the regimen administrator may have defined a first round of a first medication that follows another round of a second medication, wherein the times which these medications are taken may vary considerably. Therefore, the user device 320 identifies the current medication for the user based on the second data received from the server processing system 310. In addition, the user device 320 may include a remaining medication record indicative of the remaining amount of medication available for the user. In this particular embodiment, the user device 320 determines the current medication based on the second data as well as the remaining medication record.

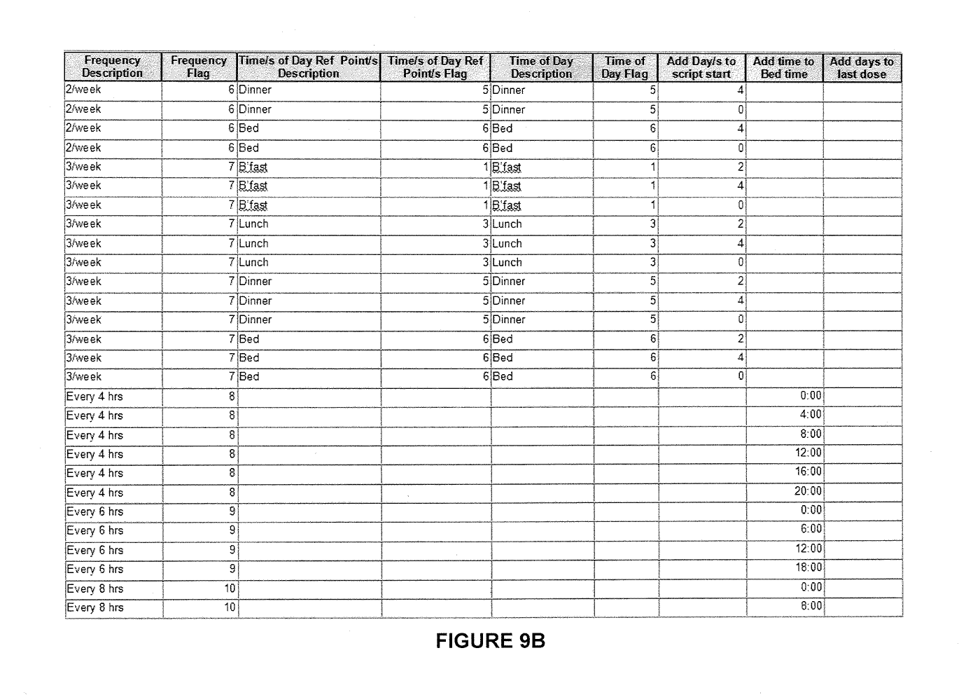

At step 820, the method 800 includes the user device 320 querying a frequency matrix stored in memory to determine frequency parameters for the current medication. An example of the frequency matrix is shown in FIGS. 9A, 9B and 9C, wherein each frequency matrix record of the frequency matrix defines the specific frequency parameters for use by the user device 320 in determining the next point in time to monitor for the patient.

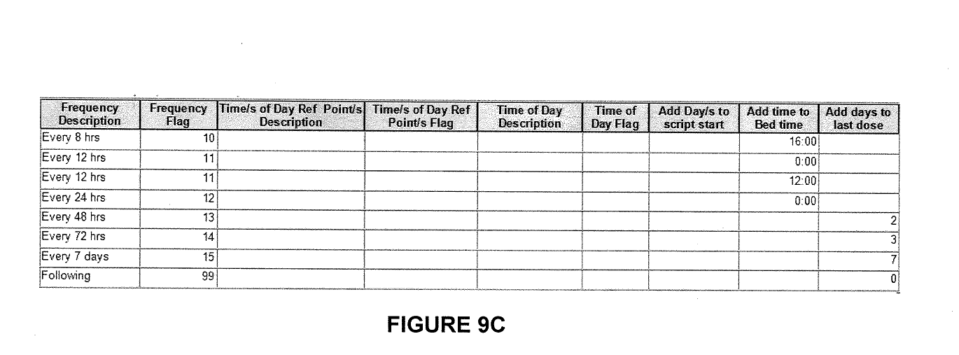

At step 830, the method 800 optionally (as indicated by dotted line) includes the user device 320 querying a block-out table stored in memory to determine block-out parameters for determining a block-out period which the medication cannot be taken should the medication not be taken at the next monitored point in time, the patient's routine is changed and/or the frequency changes. In the event that the medication is to be taken for the first time, this step may not be performed. An example of the block out table is shown for example in FIG. 10.

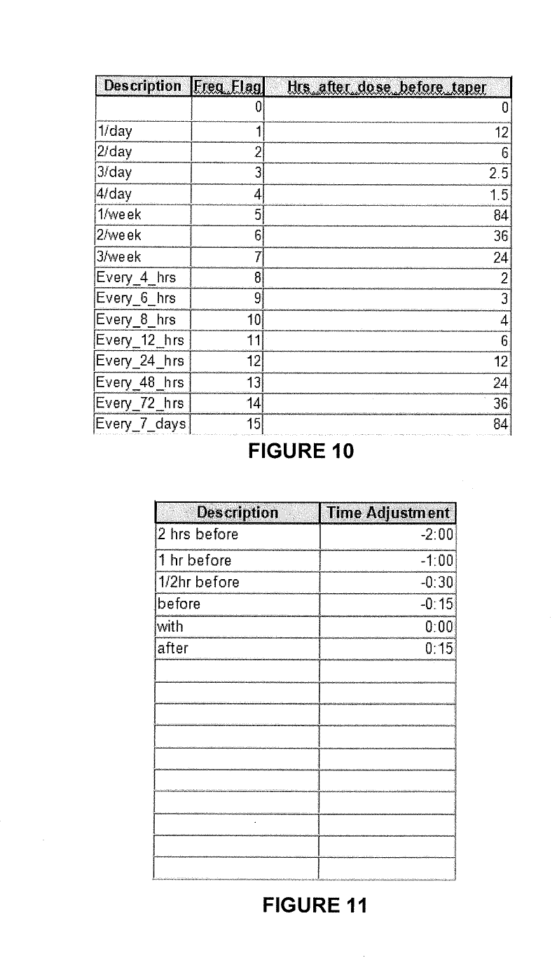

At step 840, the method 800 optionally (as indicated by dotted line) includes the user device 320 querying a meal relationship table to determine meal offset parameters which are used to determine the next point in time to take the medication. In particular, in the event that the second data indicates that the patient needs to take a drug 30 mins prior to lunch, the user device obtains meal offset parameters from the meal relationship table which are used to calculate the next point in time based on this meal relationship. An example of the meal relationship table is shown for example in FIG. 11.

At step 850, the user device calculates the next time to monitor for the patient medication regimen using at least some of the second data, the frequency parameters, and optionally the meal relationship parameters and the block out period if relevant for the specific patient and medication regimen. The next point in time to monitor by the user device is stored in memory of the user device 320 such that the user device 320 can monitor this point in time as it approaches and remind the user to undertake the particular task associated with their medication regimen.

In an optional form, a third party may be registered with the server processing system 310 to view the compliance data of a particular user 325. In particular, a carer of a patient may be registered to be able to view compliance data of a user 325. The carer can then use a processing system in data communication with the server processing system 310 to access a third party interface via a web-browser, wherein the third party interface presents a restricted form of the regimen administration interface such that the carer can determine if the user 325 has been adhering to the medication regimen.

In another optional form, the server processing system 310 may have recorded an emergency contact associated with each patient record. The server processing system 310 may automatically analyse the compliance data. In the event that the compliance data indicates that a threshold number of acts have not been performed, the server processing system 310 automatically initiates an alert. In particular, the server processing system 310 may generate an electronic message which is transferred to the emergency contact recorded in the database for the patient. Alternatively, an alert is presented to an administrator of the server processing system such that the administrator can contact the emergency contact manually.

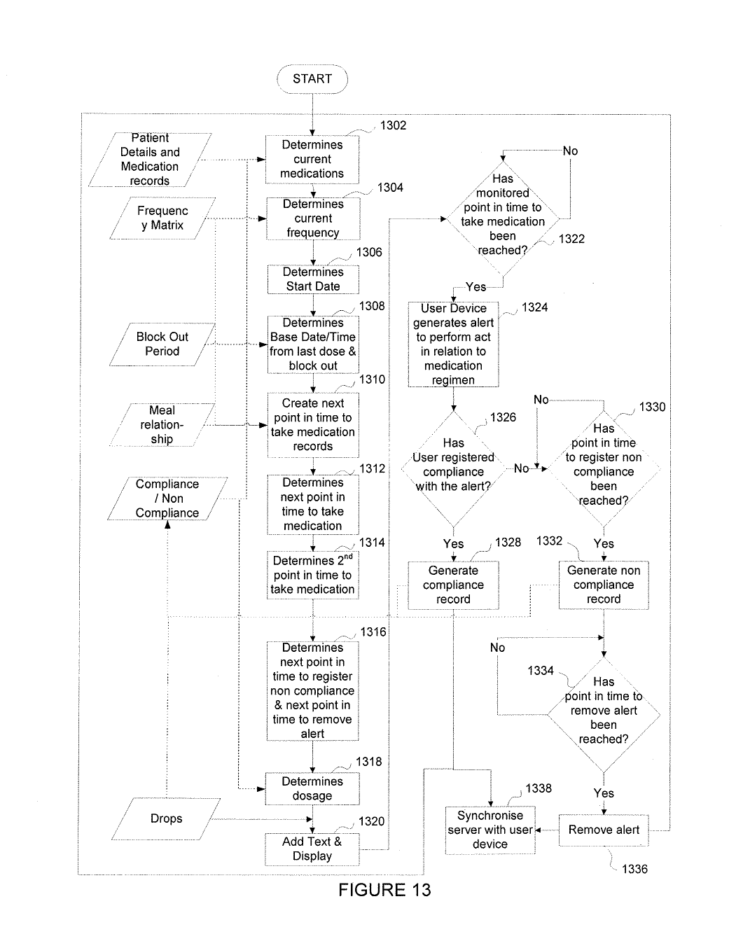

Referring to FIG. 13 there is shown a further flowchart representing a method 1300 performed by the user device 320 for calculating a next point in time to monitor for a medication regimen. As can be seen in FIG. 13, a number of sets of data are used as input to perform certain steps of the method 1300. However, prior to describing each of the steps of the method, the contents of the data sets will firstly be described.

In particular, the user device includes frequency matrix data indicative of the frequency matrix. The frequency matrix allows for the regimen administrator to provide a simple frequency selection and an extensive range of options. Converting these selections to the required point in time/s to take medication/s as intended by the regimen administrator is achieved through the use of the frequency matrix stored by the user device 320 as will be discussed in relation to FIG. 13.

The system has been designed to provide:
1. Ease of regimen entry. For most prescriptions, only medication, frequency and dosage need be selected.
2. Selection of many advanced options for weaning on or off and/or linking (or separating) from other medications.
3. Automatic due times to be generated. There is no need for third party intervention once selected—even for complicated combinations. Due times are recalculated where doses are missed.
4. Ordering medications around each other and the patient's typical meal and bed times.
5. Maintenance of routine as per pharmaceutical manufacturer's recommendations even where doses are missed.
6. Presentation of only the next due time for each medication. The rationale being that the time of the next one is not confirmed until the previous dose has been confirmed as taken.

The following framework outlined in Table 1 was developed in accordance with above.

TABLE 1
Available Frequencies for medication regimen and application

| Available Frequencies | Framework Applied |
|---|---|
| Once, twice, three or four | The due times are the same time/s of day and week even when |
| times a day | doses are missed. Missed dose rules remove the alert and |
| Once, twice or three times a | return due times to the same time/s and day/s of week if a dose |
| week | is missed. |
| Every ‘x’ hours, commonly | Avoids or minimises interruptions to sleep by linking due times |
| prescribed as 4, 6, 8, 12, hrs | to bed time. eg every 8 hrs due at bed time + multiples of 8. |
| | [Bed time]-(say) 15 mins + 0 hrs |
| | [Bed time]-(say) 15 mins + 8 hrs |
| | [Bed time]-(say) 15 mins + 16 hrs. |
| | Missed dose rules remove the alert and return due times to |
| | same time of day if a dose is missed. |
| Every ‘x’ hours, commonly | Missed dose rules return due times to same time of day, but not |
| prescribed as 24, 48, 72 or | necessarily the same day of week (This is he case anyway |
| 168 hrs | where every 48 or 72 hours is selected and complied with.) |
| | In this regard the alert is maintained until the dose has been |
| | registered as taken. The next due time is the same time of day. |
| | The day however is the nominated dwell (eg 48 hrs) since the |
| | last dose was taken rounded to the closest 12 hours to maintain |
| | the same time of day routine. |

The system was also designed to provide the following features outlined in Table 2:

TABLE 2
Features of the system and application

| Feature | Application |
|---|---|
| Medication following another | Due times and alerts may be generated a specified dwell time |
| | after another medication has been taken. |
| Frequency can be varied | Different frequencies may be preselected to take effect from |
| | specified dose numbers. |
| Dosage can be varied | Different dosages may be preselected to take effect from |
| | specified dose numbers. |
| Medication Start linked to | The start of a medication can be linked to another medication |
| another medication. | as follows: |
| | Once the preceding medication has finished, with or |
| | without lag to provide separation. |
| | When a specified volume of the preceding medication |
| | has been taken. Used in combination with varying |
| | dosage and/or frequency, this facility can be used to |
| | wean off one medication while increasing dosage or |
| | frequency of another medication. |
| Optional Doses | Due Times may be indicated as optional. |
| Instructions | Instructions and side effect information is provided. |

The above features are defined by the regimen administrator. The system also provides for real time changes to patient and medication data where consultation between the regimen administrator and patient or carer has taken place.

The software downloaded to the user device 320 contains a number of imbedded datasets including a frequency table (herein referred to as the frequency matrix), a block out period table, meal relationship table, and drops table. Fields of each table will herein be described. As will be appreciated, certain fields of tables are populated based on the value of fields in other tables and other data. Syntax used below for referring to a field in a table is [FIELD NAME] and syntax used for referring to a field in another table is [TABLE NAME: FIELD NAME].

Field descriptions for the frequency matrix are outlined below in Table 3. Table 3 includes a brief explanation where the outputs are subsequently used.

TABLE 3
Fields of the Frequency matrix

| | | |
|---|---|---|
| Field Name | Data Type | Description |

The following fields are matched with fields of the same name from the [Medication
Records] to derive subsequent outputs.

| | | | |
|---|---|---|---|
| 1. | Frequency | Text or flag | Frequency of medication. This is an input field and |
| | | | comes from [Medication Records: Current Frequency]. |
| 2. | Time of Day | Text or flag | Refers to single point of day or a combination of points |
| | Ref Points | | of the day when the medication is to be taken. |
| | | | For example if [Medication Records: Current Frequency] |
| | | | is “twice per week”, the corresponding [Medication |
| | | | Records: Current Time of Day Ref Points] options are |
| | | | “Breakfast”, “Lunch”, “Dinner” or “Bed”. |
| | | | This field is only populated where [Medication Records: |
| | | | Current Frequency] is ‘x’ per “day” or “week”. |

The following fields (where populated) are outputs for the above inputs.

| | | | |
|---|---|---|---|
| 3. | Add days to | dd | Only populated where [Frequency] is every ‘x’ hours & |
| | last dose | | ‘x’ is >24 hrs. |
| | | | Value is used in calculation of due date. |
| 4. | Time of Day | Text or flag | Provides specific reference point during day. |
| | | | For example there are two records listed where |
| | | | [Frequency] is “twice per day” and [Time of Day Ref |
| | | | Points] is “Breakfast/Dinner”. The two values in [Time |
| | | | of Day] field for these two records are “Breakfast” and |
| | | | “Dinner” respectively. These values (or flags for) are |
| | | | subsequently matched to the time in [Patient's Details: |
| | | | Routine Time] where [Patient's Details: Routine name] = |
| | | | [Time of Day], in this instance “Breakfast” and “Dinner” |
| | | | respectively. |
| 5. | Add days to | dd:hh | Only populated where [Frequency] is ‘x’ every week. |
| | script start | | Value is added to [start date/time day of week]. |
| 6. | Add time to | hh:mm | Only populated where [Frequency] is every ‘x’ hours and |
| | bed time | | ‘x’ is ≦24 hrs. Values are added to [Patient's Details: |
| | | | Routine time] (where [Patient's Details: Routine name] = |
| | | | “Bed”) less say 20 mins so that the alert is provided a |
| | | | reasonable period before the patient's typical bed time. |
| 7. | Add days to | dd:hh | Only populated where [Frequency] is every ‘x’ hours and |
| | last dose | | ‘x’ is >24 hrs. |

Variations of the above include numerical or flag values (for text for example) representing the above options and/or one or more field values (or flags in lieu) being concatenated or other unique reference.

Field descriptions for the block out period table are outlined below in FIG. 4. It includes a brief explanation where the outputs are subsequently used.

TABLE 4
Fields of the block out period table

| | Field Name | Data Type | Description |
|---|---|---|---|
| 8. | Frequency | Text (or | An input as per [Frequency Matrix: |
| | | flag) | Frequency]. |
| 9. | Hours after | hh:mm | An output where Time is subsequently |
| | last dose due | | added to [Compliance Record: Date and |
| | | | time due] of most recent record. |

Field descriptions for the meal relationship table are outlined below in Table 5. It includes a brief explanation where the outputs are subsequently used.

TABLE 5
Fields of the meal relationship table

| | Field Name | Data Type | Description |
|---|---|---|---|
| 10. | Meal Relation | Text (or | An input from [Medication Record: |
| | | flag) | Meal Relation] |
| 11. | Time | hh:mm | An output where the Time is used to |
| | adjustment | | adjust due time from [Patient Details: |
| | | | Routine time]. |

Field descriptions for the drops table are outlined below in Table 6. It includes a brief explanation where the outputs are subsequently used.

TABLE 6
Fields of the drops table

| | Field Name | Data Type | Description |
|---|---|---|---|
| 12. | Description | Text (or | An input as per entries listed in table 4. Eg “in right |
| | | flag) | eye”, “in left ear”, “in both eyes”, “in left ear” . . . etc |
| 13. | Quantity taken | Numeric | The output being the volume in millilitres of each |
| | | | prescribed drop. Ie: a millilitre consists of |
| | | | approximately 20 drops, or 0.05 ml per drop. |
| | | | Therefore were 2 drops in each eye is prescribed, and the |
| | | | dose registered as taken, the remaining quantity is |
| | | | reduced by: |
| | | | 2 × 0.1 ml (from [Drops: Quantity taken].) |
| | | | Additional selections and corresponding values may be |
| | | | added to account for various viscosities. |

As discussed, a number of datasets are generated and stored in the user device 320 during the operation of the system. These datasets include compliance records and non-compliance records. These datasets can be updated and purged periodically.

Fields of a compliance record are outlined below in Table 7.

TABLE 7
Fields of the compliance record

| | Field | Data type |
|---|---|---|
| 14. | Medication No. | Numeric |
| 15. | Generic Equivalent | Numeric |
| 16. | Due date/time | Dd/mm/yr |
| 17. | Date/time registered | Dd/mm/yr |
| 18. | Quantity remaining | Numeric |
| 19. | Adjusted remaining Quantity | Numeric |
| 20. | Dose count | Numeric |
| 21. | Is medication Finished? | Yes/No |
| 22. | Unique identifier | Numeric value in this manifestation |
| | | being a concatenation of medication |
| | | number and due date and time |

Fields of a non-compliance record are outlined below in Table 8.

TABLE 8
Fields of the non-compliance record

| | Field | Data type |
|---|---|---|
| 23. | Medication No. | Numeric |
| 24. | Medication name | Text |
| 25. | Due date/time | Date/time |
| 26. | Non Compliance registered at | Date/time |

A number of data sets are also received by the user device 320 from the server processing system 310 and stored in the memory of the user device 320. This data (referred previously as the second data) includes patient details data and medication record data.

Fields of the patient details data are outlined below in Table 9.

1.1.

TABLE 9
Fields of patient details data

| | Field | Data type | Description |
|---|---|---|---|
| 27. | Routine name | Test or flag | An input. ie “Breakfast”, “Lunch”, |
| | | | “Dinner” or “Bed”. |
| 28. | Routine time | hh:mm | An output, eg: 0700. |

Fields of the medication record data is outlined below in Table 10. Data integrity rules in the regimen administrator processing system ensures conflicting entries cannot be selected. The entries fall into the following categories.
S: Selected by the regimen administrator
A: Automatically populated upon selection of related data field from lookup tables without validation from the regimen administrator.
AV: Automatically populated upon selection of related data field from lookup tables. Validation is required by the regimen administrator.

TABLE 10
Fields of medication record data

| | Field | Category | Data type | Description |
|---|---|---|---|---|
| 29. | Medication description | S | Text | Medication name and brief text |
| | | | | signifying form, strength, & |
| | | | | dispensation volume |
| 30. | Medication Number | A | Number | Unique ID applied sequentially by |
| | | | | central server to each new medication |
| | | | | record. |
| 31. | Medication Name | A | Text | Name of medication |
| 32. | Generic Equivalent | A | Number | Reference number common across |
| | | | | brand name & generic equivalent with |
| | | | | same active and/or therapeutic |
| | | | | qualities. |
| 33. | (Dispensation) | A | Number | Quantity |
| | Quantity | | | |
| 34. | Measure | A | Text | Eg: ‘mls’, ‘gms’ |
| 35. | Form | A | Text | ‘caplet’, ‘capsule’, ‘cream’, ‘drop’, |
| | | | | ‘ear drop’, ear ointment, elixir, |
| | | | | emulsion, expectorant, eye drop, eye |
| | | | | lotion, eye ointment, eye spray, foam, |
| | | | | gargle, gel, gel sachet, granule, |
| | | | | infusion, inhaler capsule, injection, jel, |
| | | | | liniment, liquid, lotion, mixture, nasal |
| | | | | drop, nasal spray, nebule, oil, |
| | | | | ointment, oral gel, oral solution, patch, |
| | | | | powder, puff, reagent, rectal foam, |
| | | | | sachet, solution, spray, suppository, |
| | | | | suspension, swab, syrup, tablet, |
| | | | | turbuhaler, vaginal cream, vaginal gel, |
| | | | | vaginal tablet, vial and more . . . |
| 36. | Drops | AV | Text | Options include “in left eye”, “in right |
| | | | | eye”, “in both eyes”, “in left |
| | | | | nostril” . . . |
| 37. | Strength | A | Numeric | Represents gms per unit |
| 38. | Strength Unit | A | Text | Blank for tablet, capsule or per 5 ml. |
| | | | | Otherwise states unit. |
| 39. | Repeats | AV | Numeric | Default is zero. Integrity check will |
| | | | | limit maximum value. |
| 40. | History version | A | Numeric | All versions are numbered sequentially |
| | | | | and retained by the central server |
| | | | | system. Only the latest version need |
| | | | | be held on the remote device (320). |
| | | | | Useful where the original parameters |
| | | | | of a medication has been subsequently |
| | | | | changed by a Regimen Administrator. |
| 41. | Start Date and time | AV | Date/time | Defaults to date and time when record |
| | | | | is created. Can be changed by |
| | | | | Regimen administrator. |
| 42. | Medication to start | S | Numeric | Regimen Administrator may select |
| | after | | | another medication (Med B) currently |
| | | | | forming part of the patient's regimen. |
| | | | | Where selected, this field populates |
| | | | | with the unique reference number |
| | | | | (field [30]) for that medication. Where |
| | | | | selected, the start of this medication |
| | | | | (Med A) commences when status of |
| | | | | (Med B) matches parameters detailed |
| | | | | in fields [43] or [44.] |
| 43. | when previous | AV | hh:mm | Defaults to 00:00 when [Medication to |
| | medication finished + | | | start after] field is populated. Can be |
| | lag | | | changed |
| 44. | When previous | S | Numeric | Can only be selected for entry by |
| | medication reaches | | | Regimen Administrator when |
| | remaining quantity | | | [Medication to start after] has an entry. |
| | | | | Entry in this field removes any entry in |
| | | | | [when previous Medication finished + |
| | | | | lag] |
| 45. | Finish at quantity | AV | Numeric | Defaults to zero. May have value |
| | | | | entered up to a maximum of [Quantity] |
| 46. | Finish Date and time | S | Date/time | Defaults to blank. If a date and time is |
| | | | | entered by the Regimen Administrator, |
| | | | | any values in fields [43], [44], [456] |
| | | | | and [47] are deleted. |
| 47. | Finish at Dose number | S | Numeric | Defaults to blank. If a number is |
| | | | | entered by the Regimen Administrator, |
| | | | | any values in fields [43], [44], [45] and |
| | | | | [46] are deleted. |
| 48. | Frequency | S or AV | Text or | May be automatically populated for |
| | | | flag | the [Medication description] selected |
| | | | | or one of the selections from |
| | | | | [Frequency Matrix: Frequency] may be |
| | | | | selected. |
| 49. | Times of Day Ref | S or AV | Text or | May be automatically populated for |
| | | | flag | the [Medication description] or |
| | | | | Frequency selected or one of the |
| | | | | selections from [Frequency Matrix: |
| | | | | Time/s of Day Ref Point/s |
| | | | | Description] may be selected. |
| 50. | Meal Relation | S or AV | Text or | May be automatically populated for |
| | | | flag | the [Medication description] or one of |
| | | | | the selections from [Meal relation: |
| | | | | meal relation]. |
| 51. | Frequency @ taper (a) | S | Text or | Defaults to blank. Selecting entries |
| 52. | Frequency @ taper (b) | S | flag | will vary Frequency at the specified |
| 53. | Frequency @ taper (c) | S | | dose number in fields [55] to [58]. |
| 54. | Frequency @ taper (d) | S | | Selection options same as [Frequency]. |
| 55. | Times of Day Ref @ | S | Text or | Defaults to blank. Same options as |
| | taper (a) | | flag | [Times of Day Ref]. Corresponding |
| 56. | Times of Day Ref @ | S | | fields must and can only be populated |
| | taper (b) | | | where [51] through [54] respectively |
| 57. | Times of Day Ref @ | S | | are populated and frequency is ‘x’ per |
| | taper (c) | | | day or week. |
| 58. | Times of Day Ref @ | S | | |
| | taper (d) | | | |
| 59. | Freq taper at dose (a) | S | Numeric | Defaults to blank. Represents dose |
| 60. | Freq taper at dose (b) | S | | number where fields [51] to [54] and |
| 61. | Freq taper at dose (c) | S | | (where populated] [55] to [58] |
| 62. | Freq taper at dose (d) | S | | respectively takes effect. |
| | | | | Corresponding fields must and can |
| | | | | only be populated where [51] through |
| | | | | [54] have entries. |
| 63. | Optional Frequency | S | “Yes” or | Defaults to blank. If does are to be |
| | | | [blank] | optional, “Yes” is selected. |
| 64. | Limit per day | S | Numeric | Defaults to blank. This is the |
| | | | | maximum number of intake per day. |
| | | | | Eg: maximum [6] per ‘day’ |
| 65. | Preceding Generic | S | Numeric | Regimen Administrator may select |
| | equivalent. | | | another medication (Med B) currently |
| | | | | forming part of the patient's regimen. |
| | | | | Where selected, this field populates |
| | | | | with the generic equivalent reference |
| | | | | number for that medication. Where |
| | | | | selected, the start of this medication |
| | | | | (Med A) commences when status of |
| | | | | (Med B) matches parameters detailed |
| | | | | in fields [43] or [44.] |
| 66. | Time following | S | hh:mm | Defaults to blank. Entry here |
| | preceding generic | | | represents the dwell time following |
| | equivalent | | | another medication this medication is |
| | | | | to be taken. Entry here clears all |
| | | | | entries in [46] to [64]. |
| 67. | Dose | S or AV | Numeric | Dosage to be advised to the patient via |
| | | | | usage device 320 in conjunction with |
| | | | | any entries in [68] thru [75]. |
| 68. | Dose @ taper (a) | S | Numeric | Defaults to blank. Selecting entries |
| 69. | Dose @ taper (b) | S | Numeric | will vary Dosage at the specified dose |
| 70. | Dose @ taper (c) | S | Numeric | number in fields [72] to [75]. |
| 71. | Dose @ taper (d) | S | Numeric | |
| 72. | Dose taper at dose (a) | S | Numeric | Defaults to blank. Represents dose |
| 73. | Dose taper at dose (b) | S | Numeric | number where fields [69] to [72] |
| 74. | Dose taper at dose (c) | S | Numeric | respectively takes effect. |
| 75. | Dose taper at dose (d) | S | Numeric | Corresponding fields must and can |
| | | | | only be populated where [68] through |
| | | | | [71] respectively have entries. |
| 76. | Missed Dose Rule | AV | Text or | “Skip now, take next” or “Take now, |
| | | | flag | skip next”. Has capacity for more to |
| | | | | be added. |
| 77. | Time to Missed Dose | AV | hh:mm | The period before the dose after the |
| | | | | next dose is due where the Missed |
| | | | | dose rule is first applied. |
| 78. | Prescribing Doctor | A | Text | Contact details |
| 79. | Prescribing Doctor | A | #### | |
| | phone number | | #### | |
| 80. | Dispensing Pharmacist | A | Text | |
| 81. | Dispensing Pharmacist | A | #### | |
| | phone number | | #### | |
| 82. | Medication purpose | A | Text | From Consumer Medication |
| 83. | Standard Instruction 1 | A | Text | Information. Some may be blank. |
| 84. | Standard Instruction n | A | Text | Can be added to or changed by |
| 85. | Extra patient | S | Text | Regimen Administrator. May include: |
| | Instruction 1. | | | condition that the medication |
| 86. | Extra patient | S | Text | treats; |
| | Instruction n. | | | side effect warnings; and/or |
| | | | | instructions on how to take |

Referring to FIG. 13, at step 1302, the user device 320 determines if the medication record is current. ie:

a. Where the medication has started. ie
i. Where the start date and time has passed.
   ie: Where [NOW]>[Medication record: start date/time], medication has started.
   eg: It is now 14:00 7 Jul. 2012; and
      [Medication record: start date/time]=13:00 7 Jul. 2012 14:00 7 Jul. 2012 is >13:00 7 Jul. 2012.
      Therefore the medication has started.
      OR
ii. Where linked to another medication
   NB: In these and other examples the medication in question will be referred to as Med A and the other ‘linked’ medication referred to as Med B. This relationship will be established in this instance by an entry in field [42], namely [Medication record: Medication to start after] where it matches the value of any entries in [Compliance Records: Medication Number]. This represents medications currently being taken (or to be taken).
   and either:
      1. Med B has finished (plus any optional lag time).
         ie: Where most recent [Compliance record: Is medication Finished?] of Med B=‘Yes’:
         Medication has started after [Compliance record: Date/time registered]+any entry in [Medication Record: when generic equivalent finished+lag]
         eg: Now is 10:00 6 Jul. 2012;
         Most recent [Compliance record: Is medication Finished?] of Med B=‘Yes’; &
         [Compliance record: Date/time registered]=18:00 3 Jul. 2012; and
         [Medication Record: when generic equivalent finished+lag]=02:00 (ie dd:hh or 2 days)
         Therefore linked (preceding) medication has finished at 18:00 3 Jul. 2012+2 days lag=1800 5 Jul. 2012; and
         As (Now) 10:00 6 Jul. 2012 IS >1800 5 Jul. 2012; Medication has started.
         OR
      2. Med B has reached a specified remaining quantity. (Can also be specified in terms of “after ‘x’ doses” or “after ‘y’ quantity consumed.”)
         ie: Where most recent [Compliance re cord: Quantity remaining] of Med B≦[Medication Record: When previous medication reaches remaining quantity]; &
         [Compliance record: Medication number] of that other medication=[Medication record: Medication number]; Medication has started.
         eg: Value in most recent record [Compliance record: Quantity remaining] for Med B=‘28’; and
         [Medication record: When Medication number reaches remaining quantity]=30
         28 IS ≦than 30, therefore;
         Medication has started.
AND

b. If the medication has not finished.

It should be appreciated that Most recent [Compliance] record is defined as maximum value of [Compliance record: date/time registered] or [Compliance record: dose count]

In these and other examples the medication in question will be referring to it's own compliance records when determining if the ‘finish’ parameters have been satisfied or not. This relationship is established where the entry in [Medication Record: Medication Number]=any entries in [Compliance record: Medication Number]. In all instances the most recent record will be referenced as defined by [Compliance record: dose count] or [Compliance record: date/time registered]

ie:
i. the predetermined remaining quantity (usually zero) has not been reached.
   ie: Where [Compliance Record: Quantity remaining]≦[Medication record: finish at quantity].
   eg: [Medication record: finish at quantity]=“6”; and
      Most recent [Compliance Record: Quantity remaining]=“8”.
         Therefore 8 IS NOT ≦than 6 and medication has not finished.
      Alternatively a similar process can be applied to the metric of ‘once a predetermined number of doses have been consumed”.
   OR
ii. the finish date and times has not been reached.
   ie: Where NOW [Medication record: Finish Date and time].
   eg: [Medication record: Finish Date and time]=1200 5 Jul. 2012; and NOW=1200 3 Jul. 2012
      Therefore 1200 3 Jul. 2012 IS NOT ≧1200 5 Jul. 2012 and Medication has not finished.

If the medication record is not a current medication, there is no further action.

At step 1304, the server user device 320 also determines current frequency. In particular, the user device 320 looks up the most recent dose number from the compliance records and references the current frequency from the medication records dataset.
a. ie: Lookup most recent [Compliance Record: Dose Count] value.
   Where [Compliance Record: Dose Count]<[Medication Record: Frequency taper at dose (a)]
   Frequency is [Medication Record: Frequency]. If not:
   Where [Compliance Record: Dose Count]<[Medication Record: Frequency taper at dose (b)]
   Frequency is [Medication Record: Frequency @ taper (a)]. If not: Where [Compliance Record: Dose Count]<[Medication Record: Frequency taper at dose (c)]
   Frequency is [Medication Record: Frequency @ taper (b)]. If not:
   Where [Compliance Record: Dose Count]<[Medication Record: Frequency taper at dose (d)]
   Frequency is [Medication Record: Frequency @ taper (c)]. If not:
   Frequency is [Medication Record: Frequency @ taper (d)]
eg: Most recent [Compliance Record: Dose Count]=8;
   [Medication Record: Frequency taper at dose (a)]=2;
   [Medication Record: Frequency taper at dose (b)]=6;
   [Medication Record: Frequency taper at dose (c)]=15;
   [Medication Record: Frequency]=“Every 72 hrs”;
   [Medication Record: Frequency @ taper (a)]=“Every 48 hrs”;
   [Medication Record: Frequency @ taper (b)]=“Every 24 hrs”; and
   [Medication Record: Frequency @ taper (c)]=“Every 12 hrs”.
   Therefore:
      8 {from [Compliance Record: Dose Count]) IS NOT <2 (from [Medication Record: Frequency taper at dose (a)]); and
   8 IS NOT <6 (from [Medication Record: Frequency taper at dose (b)]);
and
   8 IS <15 (from [Medication Record: Frequency taper at dose (c)]).
      Therefore [Current Frequency]=“Every 24 hrs” from [Medication Record: Frequency taper (b)].

Note this process is also used for determining the [Current Times of Day ref points]—relevant where [Current Frequency] is ‘x’ per day or week.

Another way of illustrating this process is as per Table 11 below. In this example the most recent [Compliance record: Dose Count]=4. The [Current Frequency] and [Current Times of day ref points] are shaded below

TABLE 11

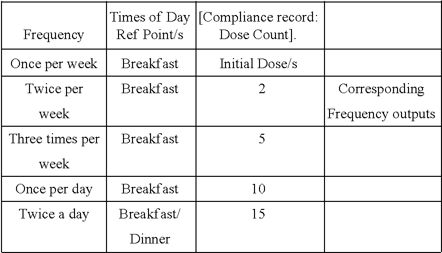

Ie: [Current Frequency]=“Twice per week”
[Current Times of Day Ref Point/s]=“Breakfast”

This data is retained as [Current Frequency] and [Current Time of Day ref Points] for subsequent use.

The start date day of the week (eg Monday, Tues etc) is used to determine due dates where medications are prescribed as ‘x’ frequency per week. Eg:
Medication is prescribed 3 times per week.
Start date is 6 Jun. 2011 which is a Monday.
Therefore due days are Monday (Monday+0 from Frequency Matrix), Wednesday (Monday+2) and Friday (Monday+4).

In instances where the prescription is filled say at 15:00 and the frequency is say 3 times a week at breakfast, the start date is the day after the prescription is filled.

Therefore at step 1306 the user device 320 determines if the first dose is due on the day defined as [Medication Record: Start Date/time] or the next day.
a. ie: [Start date]=date value of [Medication record: Start date/time];
   +1 day where time value of [Medication record: Start date/time]>Time of last dose of day.
eg: [Medication record: Start date/time]=15:00 18 Jul. 2012;
   [Current Frequency]=“Twice per week”;
   [Current Time/s of Day Ref Points]=“Breakfast”;
   [Medication record: meal relation]=“with” (meal/s); and
   [Patient Details: Routine Time]=07:00 where [Patient Details: Routine name]=“Breakfast”
      Therefore:
      15:00 IS >07:00; and
      [Start date] is 18 Jul. 2012+1 being 19 Jul. 2012

This data is retained as [Start date] for subsequent use.

Where a medication has been taken, the next due time can be calculated from ‘now’. However there are 2 scenarios where this can lead to a due time to be calculated too soon after the last one was taken. They are:

A) When frequency tapers up or down. Eg: “Once a day” at “Breakfast” (say 0700) then becomes “Twice a day” at “Breakfast” (0700) and “Dinner” (say 1900) after the 1^{st} dose. The intent is to have a dwell of 24 hrs after the first dose before the next dose is due. However if twice a day is calculated after the first dose is due at 0700, the next due time will be 1900 the same day; AND

B) When patient routine is changed. Eg: Due time is calculated ‘with lunch’ at 1200. If after the 1200 dose is taken, the routine is changed to a 1300 lunch, another ‘with lunch’ will be created for 1300 of the same day.

Therefore at step 1308, a block out period is added to the time the last dose was due. This is the base from which the next dose is calculated.
a. ie: Most recent [Compliance Record: Date & Time due] value; +.
   [Block out time: Hours after last dose due] where;
   [Current Frequency]=[Block out time: Frequency]
eg: Where most recent [Compliance Record: Date & Time due]=0700 7 Jul. 2012; and
   [Current Frequency] is “Once per day”,
   Therefore:
   [Block out time: Hours after last dose]=18:00 where [Block out time: Frequency]=“Once per day”
      Therefore [Base Date and Time]=0700 7 Jul. 2012+18:00=0100 8 Jul. 2012

The actual time the previous dose was taken is not used in this calculation as it may run contrary to application of Missed Dose Rule. If there have been no previous doses, the Base Date and Time is now.

This data is retained as [Base Time and Date] for subsequent use.

At step 1310, the user device 320 creates due time records. In particular a due time record is created for each listing of the [Current Frequency] (and where relevant [Current Times Of Day Ref Points]) in the Frequency Matrix.
a. ie: Where [Current Frequency]=[Frequency Matrix: Frequency]; and
   [Current Times Of Day Ref Points]=[Frequency Matrix: Times Of Day Ref Points]
   Create records for each listing in [Frequency Matrix].
eg: [Current Frequency]=“Three times a day” AND
   [Current Times of Day ref Point/s]=“All Meals”

Three records are created for each listing of these parameters in [Frequency Matrix]. These records will subsequently be known as [Due Record].

[Due Record] fields include:
a. Time of Day (carried over from [Frequency Matrix: Time of Day] where populated).
b. Add Day/s to script start (carried over from [Frequency Matrix: Add Day/s to script start] where populated).
c. Add time to Bed time (carried over from [Frequency Matrix: Add time to Bed time] where populated).
d. Add days to last dose (carried over from [Frequency Matrix: Add days to last dose] where populated).

In this example the fields for the three [Due Records] records are as shown below in Table 12.

TABLE 12

| | | Add Day/s to | Add time to | Add days to |
|---|---|---|---|---|
| Record | Time of Day | script start | Bed time | last dose |
| 1 | Breakfast | — | — | — |
| 2 | Lunch | — | — | — |
| 3 | Dinner | — | — | — |

Where for example [Current Frequency]=“Every 4 hours”, the six [Due Records] records are as follows in Table 13.

TABLE 13

| | | Add Day/s to | Add time to | Add days to |
|---|---|---|---|---|
| Record | Time of Day | script start | Bed time | last dose |
| 1 | — | — | 00:00 | — |
| 2 | — | — | 04:00 | — |
| 3 | — | — | 08:00 | — |
| 4 | — | — | 12:00 | — |
| 5 | — | — | 16:00 | — |
| 6 | — | — | 20:00 | — |

New fields for [Due Records] will be populated as per the following processes.

At step 1312, the user device 320 determines the due time for each [Due Record] record.
a. ie: Where [Due Record: time of day] is populated &=[Patient Record: Routine name];
   Due time=[Patient Record: Routine time]+[Meal relation: Time Adjustment] where:
   [Medication Record: Meal relation]=[Meal relation: meal relation]
eg: [Due Record: time of day]=“Breakfast”;
   [Patient Record: Routine time]=07:00 where [Patient Record: Routine name]=“Breakfast”;
   [Medication Record: Meal relation]=“Before”; and
   [Meal relation: Time Adjustment]=−00:20 where [Meal relation: Meal relation]=“before”.
      Therefore [Due Record: Due Time]=07:00+(−00:20)=06:40
   OR
b. ie: Where [Due Record: Add days to last dose] is populated;
   Due time=time value of [Medication Record: Start date/time]
eg: [Medication Record: Start date/time]=12:30 9 Jul. 2012.
   Therefore [Due Record: Due Time]=12:30
   OR
c. ie: Where [Due Record: Add time to Bed time] is populated;
   Due Time=[Patient Details: Routine time] where [Patient Details: Routine name]=“Bed”;
   −00:20 (hh:mm—so that the actual alert is generated prior to bed time); +[Due Record: Add time to Bed time]
eg: [Due Record: Add time to Bed time]=16:00.
   [Patient Details: Routine time]=22:00 where [Patient Details: Routine name]=“Bed”.
      Therefore [Due Record: Due Time]=22:00+(−00:20)+16:00=13:40

The user device 320 then determines the due date for each [Due Record] record.
d. Ie: Where [Due Record: time of day] is populated; and
   Where [Due Record: Add Day/s to script start]=zero (or is blank).
   Due Date=date value from [Base date and time]; +
      Zero days where [Due Record: Due time]>time value of [Base date & time]; or
      One day where [Due time] is not >time value of [Base date & time].
eg: [Base Date and time]=17:00 24 Jul. 2012; and
   [Due record: Due Time]=08:56 Therefore: 08:56 IS NOT >17:00; thence
      [Due Record: Due Date]=24 Jul. 2012+1 day; =25 Jul. 2012
OR
e. ie: Where [Due Record: time of day] is populated; and
   Where [Due Record: Add Day/s to script start]>zero; and either
      Apply [Base date] where:
         (weekday values of [Start Date]−[Base Date])+[Due Record: Add Day/s to script start]=0 or 7; and
         [Due Time]>[Base Time]
      OR
      Apply [Base date]+7 days where:
         (weekday values of [Start Date]−[Base Date])+[Due Record: Add Day/s to script start]=0 or 7; and
         [Due Time]<[Base Time]
      OR
      Apply (weekday values of [Start Date]−[Base Date])+[Due Record: Add Day/s to script start]+[Base Date]; +
         −7 days where:
         (weekday values of [Start Date]−[Base Date])+[Due Record: Add Day/s to script start]>6;
         OR
         Zero days otherwise (ie above formula≦6)
eg: [Due Record: Add Day/s to script start]=4;
   [Start Date] is 12 Jul. 2012 (which is a Thursday, or weekday value of 5)
   [Base Date and Time] is 16:00 17 Jul. 2012 (being a Tuesday with a weekday value of 3.)
   [Due Time] is 12:10
   Therefore:
   5 (from Start date)−3 (from Base date)+4 (Add Day/s to script start)=6.
   ie we use:
      [Base Date]+(weekday values of [Start Date]−[Base Date]+Add Day/s to script start]; which gives:
         17 Jul. 2012+[5]−[3]+[4]=23 Jul. 2012
OR
f. ie: Where [Due Record: Add time to Bed time] is populated;
   [Due date]=[Due record: Add days to last dose]+date value of [Compliance Record: date and time registered];
   −1 day where [Due time]−[Time last dose taken]>12 hrs;
   +1 day where [Due time]−[Time last dose taken]<−12 hrs; or
   +0 days otherwise.
eg: [Current Frequency]=Every 72 hours;
   [Due Record: Due time]=08:00; and
   Most recent [Compliance Record: date and time registered]=23:00 18 Jul. 2012
   Therefore:
      3 days (from [Due record: Add days to last dose]); +
      18 Jul. 2012 (from date value of [Compliance Record: date and time registered]); +
      1 day (as 08:00 (from [Due Record: Due Time]−23:00 (from time value of [Compliance Record: date and time registered])<−12=22 Jul. 2012.
   The effect being that each alert is scheduled at the same time of day rounded to the closest nominated dwell time (ie 24, 48, 72 hrs etc).

Continuing step 1310, field values are collated and some records discarded. The following fields have now been populated for [Due Records]
Due Date
Due Time

The first due of each medication is retained and the rest of the records are jettisoned. (There are only records to jettison where there is more than one due date/times for a medication in the Frequency cycle. Eg Twice per week)

Missed dose recommendations by pharmaceutical manufacturers are usually expressed in terms of “ . . . when it is almost time for the next dose” and either “Skip the missed dose and take the next one as normal” or “Take now and skip the next dose”. In this respect the time of the dose after the next due must be calculated so that a point in time can be defined as to when to apply the missed dose rule.

At steps 1314 & 1316 the user device 320 determines when to register non compliance and when to remove alerts.
a. ie: When to remove the alert ([Due record: Remove alert at]) is determined as follows.
   i. First determine the due time of the dose following the next dose at step 1314.
      a. ie: [Due Record: 2nd Due date and time]=
         i. Repeat process 5.1.6 except substitute [Due Record Due Time] and [Due record: Due Date] for [Base Date and Time] in the calculations.
   ii. Thence work backwards to define the time to remove the alert at step 1316.
      a. ie: Subtract:
         i. [Medication Record: Time before 2^{nd} dose] where [Medication Record: Missed Dose Rule]=“Skip now, Take next”
      OR
         ii. 00:15 (ie 15 minutes} where [Medication Record: Missed Dose Rule]=“take now, Skip next”
eg: [Medication Record: Missed Dose Rule]=“Skip now, Take next”;
   [Medication Record: Time before 2^{nd} dose]=6 hours; and
   [Due Record]=18:00 2 Jul. 2012.
      Therefore remove alert at:
         dose after next dose=18:00 3 Jul. 2012 (assumed for this exercise having repeated step 5.1.6 using 18:00 2 Jul. 2012 as an input instead of [Base date/time]); and
         18:00 3 Jul. 2012 —6 hrs (from [Medication Record: Time before 2^{nd} dose])
         =12:00 3 Jul. 2012.
b. When to register non compliance ([Due record: Register non compliance at]) is as for a ii a i above.

Medications may be prescribed to be taken a set interval after another medication. Eg Glucoma treatments often require a series of eye drops. (ie more than one medication taken in series.)

In creating this functionality a number of user interface outcomes need to be taken into account. They are as follows.
It is not known when the dose will ultimately be due until the preceding medication has been taken.
Nevertheless the user needs to be alerted to the following medication before hand, not just have a Due Record/Alert materialize after the preceding medication has been taken, especially if the lag is only a few minutes.

The above outcomes are facilitated by the following process. (These steps have not been included in FIG. 13 for clarity, but can occur concurrently with steps 1312 to 1316).
a. ie: Due Date & Time of Medication to follow the prescribed time of the preceding medication.=
   [Due record: Due Date and Time]+[Medication record: Time following generic equivalent] where:
      [Medication record: Preceding Generic equivalent] is populated and=[Due Record: Generic equivalent]
eg: [Due Record: Generic equivalent] & [Medication record: Preceding Generic equivalent]=0001;
   [Due Record: Due Date and Time]=12:40 14 Jul. 2012; and
   [Medication record: Time following generic equivalent]=00:30 (ie: ½ hr).
   Therefore:
      Due Time of Medication following=12:40 14 Jul. 2012+00:30=13:10 14 Jul. 2012
   NB: [Due record: time to remove alert] is blank
      This advice does not go to ‘alert’ even once the due time has passed.
      This advice is removed when the preceding medications (as defined by the [Generic reference] link is registered as taken or the missed dose rule automatically is enacted with the passage of time.

Once this advice has been removed, another Due record is created which references the date and time the preceding medication was actually registered as taken. ie:
b. Ie: Due Date and Time of Medication to following=
   [Compliance record: Date and Time registered]+[Medication record: Time following generic equivalent] where:
      [Medication record: Preceding Generic equivalent] is populated and=[Compliance Record: Generic equivalent]
eg: [Due Record: Generic equivalent] & [Medication record: Preceding Generic equivalent]=0001;
   [Compliance record: Date and Time registered]=12:57 14 Jul. 2012; and
   [Medication record: Time following generic equivalent]=00:30 (ie: ½ hr).
   Therefore:
      Due Time of Medication following=12:57 14 Jul. 2012+00:30=13:27 14 Jul. 2012

At step 1318, the same logic as that for ‘current frequency’ is applied. For example, the user device 320 looks up most recent dose number from compliance records and applies to relevant fields in Medication Records. An example is illustrated below in Table 14.

### Medication Record

TABLE 14

| Dosage | | (from) Dose No. | |
|---|---|---|---|
| Dose | 3 ml | | Initial Dose/s |
| . . . Dose taper (a)] | 5 ml | . . . Dose taper at dose (a)] | 5 |
| . . . Dose taper (b)] | 10 ml | . . . Dose taper at dose (b)] | 9 |
| . . . Dose taper (c)] | 15 ml | . . . Dose taper at dose (c)] | 13 |
| . . . Dose taper (d)] | 20 ml | . . . Dose taper at dose (d)] | 16 |

At step 1320, numerous Texts are created for each record depending on when the dose is due relative to the day the advice is displayed (eg: “Due 14:00” where dose is due during current day. “Due 14:00 tomorrow” or “Due 14:00 Tuesday” for example as required).

This next point in time to take medication is coupled with the text, name and dosage of the medication for display.

The [Due Records] are then arranged in chronological order and displayed as “Due Advice”, i.e. upcoming medications which are not yet due. At step 1322, the user device 320 monitors against the on board clock.

While ever the “Due advice” is displayed, the next point in time to take the medication has not yet passed. If the user attempts to register too early the user device provides a warning not to take the medication and to seek medical assistance if they have indeed already taken the medication. (A nominal period before due time is allowed without generating a warning if say the user registers 10 minutes early.)

Once the next point in time to take medication has been reached, the “Due advice” turns to “Due Alert” as indicated by step 1324. The alert is signified by the user device 320 providing stimuli available. eg colour change, flashing, chime and/or other audible chimes once the due time passes.

At step 1326, if the user does not register compliance by the point in time to register non compliance (otherwise known as date and time represented in field [Due record: register non compliance at]) at step 1330, a record is appended to the Non compliance dataset at step 1332.

Continuing onto step 1334, if the user has still not registered compliance by the next point in time to remove the alert date and time represented in [Due record: Remove alert at], the alert is removed at step 1336 and the next [Due record] is calculated and displayed.

Non Compliance data captured includes:
Medication name and number
Date and time due
Date and time registered non compliant

If instead of not responding to the alert at step 1326, the user does respond, to the Due Alert, a confirmation screen appears prompting the user to confirm that the medication has been taken.

The confirmation screen will or may include:
Medication name
Dosage
Form (eg tablet, syrup, vial, inhaler, etc)
Side effect warnings
Instructions on how to take
Prompt to confirm
Doctor &/or Pharmacist contact details

Non response to this screen will see the display revert to the medication listing after a pre set period.

Once this confirmation screen is responded to by the user, a record is appended to the Compliance dataset as per step 1328.

Compliance data fields captured include:
Medication name and number
Date and time due
Date and time registered;
Generic equivalent
Remaining quantity
   This is derived from the previous [Compliance record: remaining quantity]−[Current Dosage].
      Eg: Most recent compliance record shows (Compliance: Remaining Quantity]=16 tablets; and
         [Current Dosage] is 2 tablets.
         Therefore:
         16−2=14 tablets remaining.
   However drops are treated differently as below.
      Drops are signified by flags in the field [Medication record: Drops].
      Remaining Quantity is drawn down by value in [Drops table: Dose taken multiple]×dosage. Eg:
      Where:
         Most recent [Compliance record: remaining quantity]=5 ml;
         [Current Dosage] is 2 drops; and
         [Medication Record: Drops] indicates “in each eye”;
         ie: New [Compliance record: remaining quantity]=5−(2 (drops)×0.10 (from [Drops table: Dose taken multiple])).
         =4.80 ml
[Is medication finished?] This is populated with “Yes” where one of conditions in 5.1.1 Current Medications b) is met. Ie:
   [Compliance record: Remaining quantity}≦[Medication record: finish at remaining quantity]; or
   [Medication record: finish at date/time] has passed.

Once a compliance record is appended or a Due Alert removed, the process loops back around to step 1302. Synchronisation with the server processing system 310 occurs periodically if a communication network is available.

It will be appreciated that only the next point in time which each medication is due is displayed by the user device 320. The rationale being that the next point in time which a respective medication is due cannot be determined until confirmation has been received from the patient regarding the medication having been taken at a particular point in time. Thus, this feature eliminates problems associated with potential overdoses.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although a preferred embodiment has been described in detail, it should be understood that many modifications, changes, substitutions or alterations will be apparent to those skilled in the art without departing from the scope of the present invention.

1. A user device for indicating to a user to undertake a particular act in relation to a medication regimen, wherein the user device includes a processor, a memory, a communication unit, and an output interface, wherein:
the communication unit receives, from a server processing system in data communication with the user device, data relating to a medication regimen;
the memory stores therein the data relating to the medication regimen;
the processor calculates, using the data relating to the medication regimen, a first point in time for the user to perform an act in relation to the medication regimen;
the memory stores the first point in time in the memory; and
the processor monitors whether the first point in time has been reached, wherein in response to the first point in time being detected the processor generates an alert which is output via the output interface to indicate to the user to perform the act in relation to the medication regimen.

2. The user device according to claim 1, wherein the user device includes an input interface which receives user input from the user indicating that the act has been performed, wherein data indicative of the user input is stored in the memory.

3. The user device according to claim 2, wherein the processor calculates, prior to the first point in time and using the data relating to the medication regimen, a second point in time which occurs after the first point in time and indicative of non-compliance in relation of the medication regimen, wherein in the event that the user provides the user input indicating that the act was performed between the first point in time and the second point in time, the processor stores in the memory a compliance record.

4. The user device according to claim 3, wherein the processor controls the communication device to transfer the compliance record to the server processing system for recordal.

5. The user device according to claim 3, wherein in response to the user providing the user input indicating that the act was performed between the first point in time and the second point in time, the processor controls the output device to cease output of the alert, calculates a next point in time to perform a next act in relation to the medication regimen based on the data indicative of the medical regimen, stores the next point in time in the memory, and monitors the next point in time to output a respective alert in relation to the next act.

6. The user device according to claim 3, wherein in the event that the user fails to provide the user input indicating that the act was performed between the first point in time and the second point in time, the processor stores in the memory a non-compliance record.

7. The user device according to claim 6, wherein the processor controls the communication device to transfer the non-compliance record to the server processing system for recordal.

8. The user device according to claim 6, wherein the processor calculates, prior to the first point in time and using the data relating to the medication regimen, a third point in time which occurs after the second point in time, wherein the processor stores the third point in time in the memory, wherein in the event that the user fails to provide the user input indicating that the act was performed between the second point in time and the third point in time, the processor controls the output device to cease output of the alert.

9. The user device according to claim 8, wherein the data stored in the memory relating to the medication regimen includes missed act data, wherein in response to the user failing to provide the user input indicating that the act was performed between the second point in time and the third point in time, the processor outputs via the output device a missed act alert indicating whether the act is to be performed by the user in accordance with the missed act data, and wherein the processor calculates the next point in time to perform the next act additionally based on the missed act data.

10. The user device according to claim 2, wherein the user inputs, via the input interface, meal time data indicative of a plurality of times which meals are expected to occur for the user, wherein the processor stores the meal time data in the memory, wherein the processor calculates the first point in time additionally based on the meal time data stored in the memory.

11. The user device according to claim 2, wherein the user inputs, via the input interface, sleep time data indicative of a time which the user expects to go to sleep, wherein the processor stores in the sleep time data in the memory, wherein the processor calculates the first point in time additionally based on the sleep time data stored in the memory.

12. The user device according to claim 1, wherein the alert is at least partially output visually via the output interface.

13. The user device according to claim 12, wherein the alert is at least partially output audibly via the output interface.

14. The user device according to claim 13, wherein the user device includes a tactile module which is controllable by the processor, wherein the alert is at least partially output by the tactile module under control of the processor.

15. The user device according to claim 1, wherein the user device is one of:
a mobile telecommunication device; and
a mobile communication device.

16. A system for indicating to a user to undertake a particular act in relation to a medication regimen, wherein the system includes a server processing system in data communication with a user device, wherein:
the server processing system includes a server processor and a server communication unit, wherein:
the server communication unit receives, from a regimen administrator processing system, first data relating to a medication regimen;
the processor stores the medication regimen in the memory associated with or accessible by the server processing system; and
the server communication unit transfers second data relating to the medication regimen to the user device; and
the user device includes a processor, a memory, a communication unit, and an output interface, wherein:
the communication unit receives, from the server processing system, the second data;
the memory stores therein the second data relating to the medication regimen;
the processor calculates, using the second data relating to the medication regimen, a first point in time for the user to perform an act in relation to the medication regimen;
the memory stores the first point in time in the memory; and
the processor monitors whether the first point in time has been reached, wherein in response to the first point in time being detected the processor generates an alert which is output via the output interface to indicate to the user to perform the act in relation to the medication regimen.

17. The system according to claim 16, wherein the processor calculates and stores in the memory, prior to the first point in time and using the second data relating to the medication regimen, a second point in time which occurs after the first point in time and indicative of non-compliance in relation of the medication regimen, wherein in the event that the user fails to provide user input via an input interface of the user device indicating that the act was performed between the first point in time and the second point in time, the processor stores in the memory a non-compliance record which is transferred to the server processing system for recordal.

18. The system according to claim 17, wherein the server processor receives a plurality of non-compliance records from the user device, wherein the server processor determines whether a non-compliance threshold has been satisfied based on at least some of the plurality of non-compliance records received from the user device, and in response to a positive determination the server processing system transfers an electronic message indicative of the user's non-compliance to at least one of a regimen administrator associated with the regimen administrator processing system, a carer associated with the user, and an emergency contact associated with the user.

19. The system according to claim 16, wherein the system includes the regimen administrator processing system which is operated by a regimen administrator to provide the first data indicative of the medication regimen.

20. A non-transient computer readable medium including executable instructions for configuring a user device to indicate to a user to undertake a particular act in relation to a medication regimen, wherein the user device includes a processor, a memory, a communication unit, and an output interface, wherein upon execution of the executable instructions the user device is configured to:
receive, from a server processing system in data communication with the user device and via the communication unit, data relating to a medication regimen;
store, in the memory, the data relating to the medication regimen;
calculate, using the processor and the data relating to the medication regimen, a first point in time for the user to perform an act in relation to the medication regimen;
store, in the memory, the first point in time; and
monitor, using the processor, whether the first point in time has been reached, wherein in response to the first point in time being detected the processor generates an alert which is output via the output interface to indicate to the user to perform the act in relation to the medication regimen.
